(19) United States
(12) Patent Application Publication
(10) Pub. No.: US 2025/0189334 A1
(43) Pub. Date: Jun. 12, 2025

(54) SYSTEMS AND METHODS FOR OCCUPANT AND LANE SENSITIVE NAVIGATION

(71) Applicant: Adeia Guides Inc., San Jose, CA (US)

(72) Inventors: Dhananjay Lal, Englewood, CO (US); Reda Harb, Tampa, FL (US)

(21) Appl. No.: 18/532,259

(22) Filed: Dec. 7, 2023

(51) Int. Cl. G01C 21/36; G01C 21/34

(52) U.S. Cl. CPC G01C 21/3658; G01C 21/3461; G01C 21/3492; G01C 21/3617

(57) ABSTRACT

The disclosed system retrieves information relating to road segments from a start location to a destination by determining a first travel duration from the start location to the destination along a route and determines whether any road segments include restricted lanes. If a road segment includes a restricted lane, the system determines whether the number of occupants meets the occupancy-based restriction. If the number of occupants does not meet the restriction, navigational directions are displayed that do not include the restricted lane. If the number of occupants of the vehicle meets the restriction, a second travel duration is determined using the restricted lane. If the second travel duration is shorter than the first travel duration, navigational directions are displayed that include the restricted lane. If the second travel duration is not shorter than the first travel duration, navigational directions are displayed that do not include the restricted lane.

### BACKGROUND

The present disclosure relates to providing navigational directions and, more specifically, relates to occupant and lane sensitive navigation.

### SUMMARY

Navigation applications such as in-car navigation systems, Google Maps, Apple Maps, and Waze do not consider the number of occupants in a vehicle and therefore cannot calculate the fastest route because they cannot differentiate between HOV and non-HOV lanes. On the other hand, urban and suburban areas often contain toll roads, or High Occupancy Toll (“HOT”) roads/lanes that are typically free for vehicles with a requisite occupancy, or with toll for vehicles that don't meet the high occupancy threshold. Some areas also have High Occupancy Vehicle (“HOV”) roads/lanes for use with requisite number of occupants. Such occupancy-based lanes encourage people to travel with more people in a vehicle, which preserves resources and reduces per person pollution. When occupancy is not considered in routing, it can often lead to a sub-optimal navigation result, as a user is forced to balance personal preferences for calculating routes that “avoid tolls” on the one hand and finding the fastest estimated time to arrival (ETA) on the other.

If the user elects to implement settings that avoid tolls, existing navigation systems may disregard HOT lanes despite the user meeting the occupancy threshold. A related issue is that existing navigation applications may not be able to distinguish between high occupancy lanes, high occupancy toll lanes, and regular traffic lanes, especially when such lanes run adjacent and parallel to each other. This exacerbates the problem of accurately routing for fastest ETA, since travelling in an express lane may significantly differ from travelling in a regular lane.

Often, navigation applications disregard the express lanes on a highway altogether because they are unable to distinguish average speeds on toll/HOV/HOT lanes from the unrestricted lanes. For HOV lanes, this means they disregard the capability to use occupancy to take advantage of the faster lane. For simple toll express lanes, they disregard the capability to pay a toll to travel in a faster lane. For HOT lanes, they disregard the capability to either pay toll or use occupancy to travel in a faster lane.

Existing navigation applications handle these ambiguous scenarios by allowing the user to either “avoid toll roads” or to “allow toll roads” in the navigation settings. The ability to consider the number of occupants to determine whether a user can travel in a HOT lane without toll fee does not exist. Even if a user could get to their destination toll-free based on occupancy, they would be presented with this option only if they allow toll roads in the navigation, and it would be presented as an option with inaccurate expected tolls. Similarly, when express lanes are co-located with unrestricted lanes on a highway, the navigation applications do not indicate the presence of these lanes nor show the user an accurate ETA due to their inability to distinguish speeds between express/toll and unrestricted lanes.

Currently available navigation systems model road networks using directed graphs. To find the fastest route, shortest distance route, lowest fuel consumption route etc., each segment in the road network, equivalent to a unit area on a map, is modeled as a small graph with weighted edges. In such existing mapping applications, the weight represents a cost. For example, to find a route with the shortest distance, each segment is represented by a graph with ingress and egress points as vertices, and edges with distances as costs/weights. Similarly, to calculate a route with the fastest ETA, the cost of each edge may be the time taken to traverse that edge belonging to a segment. Other factors such as weather, traffic, average speed, road conditions, etc. may also be properties of an edge, or they may indirectly affect the cardinal edge properties such as distance and time. The vast majority of requests to navigation services seek to find the shortest ETA, i.e., to minimize the time taken to reach the destination. Once the directed graphs of all the segments in a road network with the properties of each edge are available to a computation engine, an algorithm such as Dijkstra's algorithm or A* algorithm is applied to find the least cost path from the source to the destination. Many optimizations are used to make the fastest route algorithm search efficient so that modern servers can facilitate a large number of navigation requests at scale. Another consideration is that the weights of edges in the road network must be refreshed as traffic conditions or road conditions change. For example, currently available techniques must revise determined routes/times based on increases or decreases in traffic congestion, detected road events (e.g., accidents, constructions zones, road closures, whether conditions, etc.).

Currently available techniques require the user to input certain criteria. For example, the user may choose to avoid tolls. The system may then associate a significantly higher cost with toll roads, such that the search algorithm favors toll-free roads over toll road options, even if they are slower. Alternately, such a system removes all toll road options in route calculation. When such systems fail to find a solution, they add toll roads in a subsequent iteration, and recalculate the route. However, as discussed, many such roads or lanes are High Occupancy Vehicle Toll roads or lanes (HOT), i.e., they may be used without toll payment if the vehicle occupancy is determined to be high or above a predefined number. Thus, the car occupants must manually optimize their route by turning off the “avoid tolls” option if they are aware of the presence of HOT roads/lanes along their route.

Some available mapping applications allow users to “turn on HOV, fast lane, and toll road routing,” such that the navigation application will suggest routes with fast lanes when calculating optimal navigation. Such navigation systems are deficient because they cannot automatically determine whether a road/lane is toll-free or requires toll payment based on vehicle occupancy.

Navigation applications typically determine traffic speeds on a road/highway using anonymous crowdsourcing. For example, Google® uses crowdsourcing to determine traffic conditions. When Android phone users activate the Google Maps application with GPS location enabled, the phone sends bits of data, anonymously, to Google indicating how fast cars are moving. Google Maps continuously combines the data coming in from all the cars on the road and sends it back by way of those colored lines on the traffic layers. As more and more drivers use Google's application, the traffic predictions become more reliable. Google Maps is deficient because when it does not have enough data to estimate the traffic flow for a particular section of road, that section will not have any traffic information.

Therefore, what is needed is a navigation system that offers utility and convenience to users and solves inaccurate modeling issues by modeling high occupancy toll lanes (HOT) and high occupancy vehicle lanes (HOV) in the underlying path determination algorithm.

The methods, systems, and techniques of the present disclosure provide numerous advantages over existing systems. For example, certain implementations of the present disclosure preprocess road network conditions to change weights of segments based on vehicle occupancy. As another example, the present disclosure calculates differentiated average speeds of lanes on a roadway and, in some implementations, does so whether the roadways run adjacent and in parallel with one another or are perpendicular.

Calculating movement speeds for vehicles in the different lanes, as discussed herein, has multiple use cases. For example, express lane speeds (HOV/HOT/Toll) calculated separately from the other lanes when such lanes are co-located (i.e., parallel and adjacent) with the unrestricted lanes help provide more accurate ETAs for people not only considering using the express lanes, but also those using the unrestricted lanes. The information could also be used to guide users to change lanes when beneficial or required, such as to take an upcoming exit, to distribute traffic across lanes on a road or highway, to help users avoid lane-specific congestion and slow movement, and to help users avoid an emergency services vehicle such as a police vehicle or ambulance.

In an exemplary implementation of the present disclosure, vehicle occupancy is determined. In some implementations, determining occupancy is achieved by user input via a user equipment device, e.g., a consumer device application (when using a personal device navigation system that is separate from the vehicle navigation system) or using the in-vehicle navigation system or infotainment system. In some implementations, the vehicle navigation system may also calculate the number of occupants based on weight sensors integrated within each seat of the vehicle (i.e., number of occupied seats) or seatbelt clicks (i.e., number of engaged seatbelts). In other implementations, an imaging camera, depth sensing camera, etc. are used to determine occupancy. In such an implementation, the system may monitor the image received and determine which seats have humans (using, e.g., facial or body features, and change in posture with time) versus some seats that have either inanimate objects or pets. In some implementations, wireless presence detection techniques that rely on channel sounding may be used to detect the number of occupants. In other implementations, the system may detect the number of personal devices such as smartphones or tablets that have short range RF transceivers (ex., Bluetooth, UWB) using beaconing technology and use this to estimate the number of occupants. Such devices may also be associated with user profiles and may be known to the vehicle's systems (e.g., a user profile stored at a local or remote database). The contemplated implementations of the present disclosure may use any combination of the above, and in some implementations, seek confirmation of the number of occupants from the driver or car occupants using an interface such as an LCD screen or voice assistant/NLP.

In some implementations, vehicle occupancy is calculated periodically. In some implementations, occupancy is determined once the vehicle is placed in a driving condition (e.g., the transmission is shifted to “drive”). In other implementations, occupancy is continuously determined. In yet other embodiments, occupancy is determined periodically, for example, every 30 seconds. In other implementations, occupancy is determined while the car is not in motion, to ensure an updated value. Such an implementations is useful with ride sharing services, where the number of occupants may change along the way to the destination. Thus, the system may automatically reconfigure a calculated route or toll based on eligibility to use HOT roads due to high occupancy, or it may recalculate an ETA based on eligibility to use HOV lanes as more users enter the vehicle.

Once vehicle occupancy is determined, the disclosed system retrieves driving options configured by the user. Such parameters are used to calculate and determine solutions to the underlying optimization problem, i.e., the route search. For example, whether the user desires to minimize time to destination at the expense of tolls, whether the user desires to avoid tolls even if doing so results in a later ETA, or whether the user desires to minimize the route time subject to a maximum cumulative toll fee.

The disclosed system retrieves road network information related to routes between the source and destination. In some implementations, such road network information is a data structure that represents a graph. Such implementations are scalable for route computation. In some implementations, road networks are divided into segments that represent unit areas on a map. These segments have ingress and egress points that may be represented by smaller, more granular graphs with edges that have weights. The weights represent the edge properties such as time to traverse, average speed, distance, total toll fees of determined routes, etc. Multiple segments can also be coalesced into a “mega-segment” for ease of data representation and route computation. Such segments or “calculated paths” in each segment are stored in temporary or permanent memory for ready recall in route calculation and search.

Based on the straight-line distance between the source and destination, the disclosed system creates termination conditions for the graphs. For example, if the straight-line or aerial distance between the source and destination is, e.g., 5 units, the system may set a termination condition of a maximum of 10 units of distance in any direction, thus restricting the number of segments to be considered relevant in the search.

After determining the relevant segments based on termination conditions, the disclosed system determines whether a Toll/HOV/HOT lane or road exists within that segment. In some implementations, such information is retrieved from a database. If there is no HOT/HOV road/lane, the system considers the next relevant segment. However, if an HOT/HOV lane/road exists, the system determines whether the vehicle occupancy meets any of the criteria for using the HOT/HOV lanes/road such that a reduced toll or toll-free transport, or a reduced travel time is possible.

The disclosed system determines whether the HOT/HOV lanes/road and unrestricted lanes/road are parallel and/or adjacent to each other. If such roads/lanes are co-located, the system determines differentiated speeds for the express (HOV/HOT) lanes from the “regular” lanes (i.e., unrestricted lanes) (as described herein). Based on determining whether the occupancy criteria are met, the system uses the HOT/HOV average lane speeds or unrestricted lane average speeds, respectively to determine the time to traverse the road sections in that segment. These traversal times based on the differentiated speeds of HOT/HOV, or unrestricted lanes are applied as the weights of the edges representing these roads. In implementations where the user opts to incur toll payments, the system applies time traversal in an HOT lane as the edge weight. If not, the system may default to time traversal in unrestricted lanes. Similarly, if Toll lanes are contained in a segment, the system calculates differentiated speeds of the Toll lanes from the unrestricted lanes and applies edge weights based on traversal time in the toll lanes if tolls are allowed, or traversal time in the unrestricted lanes if tolls are to be avoided/not allowed.

In some implementations, the determined graph is input to the traversal and search algorithm to generate the recommended route(s) once the weights have been adjusted for all the relevant segments. Edges associated with tolls in a segment may be “marked” or represented separately than edges that are toll-free. The search algorithm determines suitable disposition of these edges for calculating the route, e.g., based on user preferences. In some implementations where the user configured the navigation system to avoid tolls, only the edges that are not associated with tolls are input to the search algorithm. If the search algorithm is unable to find a solution, in a subsequent iteration, edges with toll are admitted to the search algorithm input.

In some implementations, the weight of edges in a segment are modified based on vehicle occupancy. In an example where a section of a road AB is running in a segment. For simplicity, only a single road in the segment is considered, and directionally vehicles move from A to B. In this example, the road is a High Occupancy Toll (HOT) road. For a vehicle with an occupancy of a single individual, the user would have to pay a $1 toll to use this road, and it would take the user 5 minutes (edge weight: 5) to traverse this section. However, with a vehicle occupancy of four, the user would not have to pay toll, although it would still take 5 minutes to traverse from A to B. If the user has configured the navigation system to avoid tolls, then in the first pass, AB would not be considered by the search algorithm since its usage incurs tolls. However, at a vehicle occupancy of 4, it would be considered in the first pass by the search algorithm, even though its weight has not changed.

In a similar example, the same road segment represents a highway that has both HOV and unrestricted lanes. The time to traverse AB in the HOV lane is 5 minutes (Edge weight: 5), while to traverse AB in the unrestricted lanes is 20 minutes (Edge weight: 20). In such an example with a vehicle occupancy of four, the vehicle is eligible to use the HOV lane, and the weight is 5. However, in the same example with a vehicle with occupancy of one, such a vehicle is not eligible to use the HOV lane, resulting in an edge weight of 20.

In some implementations, the navigation system may also use alternate methods to calculate optimal routes, such as considering the edges that incur tolls in the first pass even if the user has configured the system to avoid tolls but modifying the weights of these edges to increase the cost.

In some implementations, vehicles use a switchable transponder or similar device to configure the vehicle for either HOV or Toll lane. If vehicle occupancy requirements are met, the transponder should be configured to be read as HOV eligible. If the vehicle does not meet the required occupancy, it is not eligible for HOV and the transponder should be configured to read as Toll-eligible. In some implementations, once the vehicle occupancy is calculated, the system may remind the user to set their switchable transponder accordingly, for example “Please change your EZPass setting to HOV”. This may be undertaken after an optimal route has been calculated so that the navigation system is aware of the Express Lanes enroute to the destination. In other implementations, a switchable transponder is able to communicate its state with the vehicle or consumer navigation system. In such an implementation, the system may determine the current state of the transponder, determine whether the transponder setting needs reconfiguration, and then direct the user to make a required change, via a visual or audio user interface. In yet other implementations where the switchable transponder is automatically operated, a change can be made directly by the navigation system. The user may be informed of the change made.

In another implementation, toll fees for HOT lanes/roads are automatically determined and paid (if required) based on the vehicle occupancy. In such an implementation, whether the vehicle is travelling on a restricted road is determined by using the vehicle's onboard GPS system. Alternatively, license plate readers may determine whether the vehicle is travelling in a restricted lane/road. The vehicle's occupancy is determined using onboard systems, for example, sensors or imaging devices that determine the presence of occupants (as discussed herein). When the vehicle is determined to be travelling in an HOT lane, the occupancy is determined. If the occupancy requirement is met, the vehicle reports such to the toll agency (or other organization that regulates and controls toll lane usage) thus resulting in toll-free use of the HOT lane. Conversely, if the occupancy requirement is not met, the vehicle reports such to the toll agency. In such circumstance, a user profile (or other account) associated with the vehicle is charged the requisite toll. In some implementations, tolls are determined continuously or at discreet temporal intervals (e.g., 30 seconds, 5 minutes) or discrete distance intervals (e.g., every 0.1 miles). In such implementations, tolls may be granularly determined and assessed, for example, every 0.1 miles or every 30 seconds of travel in an HOT/toll lane. In this way, vehicle occupancy is automatically determined without the use of a dedicated transponder (or other device), and any required tolls are paid without any user interaction.

In some implementations, the disclosed system analyzes a statistical distribution of a congested highway with express lanes (e.g., Toll/HOV/HOT) in one direction. For example, the unrestricted lanes of the highway move at a lower average speed than the express lanes. In such an example, the distribution of vehicle speeds crossing a reference point on the road is bimodal. One mode occurs at a lower speed with a higher peak for unrestricted lanes while the other mode representing the express lanes is less pronounced (typically lesser number of vehicles) and occurs at a higher speed.

In some implementations, the left lane(s) are typically reserved for express lanes and some techniques of the present disclosure differentiate the vehicles assigned to one mode of average vehicle velocity from another mode of average vehicle velocity using statistical techniques that inspect latitude and longitude together with the vehicle velocities. For example, on a highway running South to North, vehicles in the express lane (left side) will report a slightly lower value of longitude than vehicles in the unrestricted lane in the eastern hemisphere (in the western hemisphere, express lane vehicles will report a slightly higher longitude than those in unrestricted lanes). Similarly a highway running East to West is considered, the vehicles in the express lane (on the left side of the highway) will report a slightly lower value of latitude than vehicles in the unrestricted lanes in the northern hemisphere. These differences in latitude or longitude or both for the two groups of vehicles are used in determining the differentiated average speeds in express and unrestricted lanes for a highway that runs in an arbitrary direction by generalizing the vehicles on the roadway.

The techniques of the present disclosure include calculating differentiated speeds for unrestricted and express lanes. In an implementation, static inputs include the highway segment direction (or start and end points coordinates) and the location of the express lane with respect to the unrestricted lanes (e.g., left or right, typically left side). The dynamic, time varying input applied periodically at a location for which this calculation is performed are the GPS coordinates and average velocities of the cars passing through that location. Algorithmically, the system may first compute the modes (of average speed) for the two groups of vehicles, i.e., unrestricted and express lanes. This is cascaded to a “relative position estimator” that computes which mode (i.e., average speed) is statistically more likely to represent the express lane based on the GPS coordinates of the vehicles passing through. Finally, this is cascaded to a “regular to express volume ratio estimator.” This module, if available, estimates the number of lanes of unrestricted traffic relative to the number of express lanes using, for example, historical information or other information retrieved from a database. The system validates (or invalidates) the findings of the “relative position estimator” by determining whether the ratio of the volume of cars expected to travel on the unrestricted lanes as compared to the express lanes at a location are in alignment with the findings of the “relative position estimator.” In some implementations, rather than using the algorithmic approach, a machine learning technique such as clustering may be employed to determine the differentiated speeds.

Additionally, a relative position estimator as described herein, may be used to determine the lane in which a vehicle is travelling. With an estimation error of 3-5 m, it is possible to pinpoint the lane of travel with a potential of misestimating it by one lane, either to the left or right. As GPS satellites or devices evolve, it may be possible to reduce this error in the future (or current techniques such as DGPS or RTK, Real Time Kinematics may be used to increase precision).

In some implementations, calculating the distribution of velocities followed by relative position estimation (or equivalent ML technique, as discussed herein) helps localize vehicles to a lane, or groups of vehicles to adjacent lanes, depending on traffic conditions. This information may be used by the system in multiple ways.

As an example, certain features of the present disclosure include explicitly advising a user when to take an express lane: the present disclosure describes how differentiated velocities for the express lanes from the unrestricted lanes may be derived. Such differentiation may be used by a navigation system to calculate a more precise ETA or toll requirement and also be used to guide a user on when and/or where to enter or exit an express lane. The navigation system may detect whether the user has moved into an express lane in accordance with directions and update the navigation information. For example, it may recalculate the route ETA by changing the edge weight that represents the time spent in a differentiated HOV lane back to an edge weight that represents the time spent in an unrestricted lane.

As another example, certain features of the present disclosure include advising a user when to begin changing lanes for an exit: for example, the navigation system may identify that a user is in, e.g., the left-most lane of a highway, and based on the calculated route, it may determine that the user has to take an exit by crossing, e.g., six lanes to the right in the next few miles. The system may display a message explicitly notifying the user in its navigation guidance. For example, the navigation system displays, “Exit ahead in 1 mile. Begin moving to the right lane.”

As another example, certain features of the present disclosure include advising a user how to change lanes prior to impending congestion: in some implementations of the present disclosure, a navigation system may advise a user to change lanes ahead of time due to impending congestion in one or more lanes that are detected along the user's determined route. Changing lanes before reaching congestion helps reduce lane changes required after already entering the congested segment. It may also reduce travel time for a user. Additionally, it may be used by a navigation system to distribute traffic more evenly across lanes, thus helping to mitigate or eliminate traffic congestion.

As yet another example, certain features of the present disclosure include recommending a user to move deterministically to make way for an emergency vehicle: in some implementations of the present disclosure, emergency vehicles benefit from lane awareness of navigation systems. The emergency vehicle itself may indicate its location to a navigation system, which may then warn users on the path of the emergency vehicle. In such an example, the emergency vehicle may undergo a registration process whereby the emergency vehicle's identity as an emergency vehicle is confirmed. The emergency vehicle's identity as an emergency vehicle may be included in a profile associated with the emergency vehicle. In this way, when such an emergency vehicle reports its location to, e.g., a database or other GPS tracking system, the location of the emergency vehicle is known and, in some implementations, is retrievable by publicly available GPS systems.

In some implementations, systems of methods of the present disclosure guide users to move out of the way of emergency vehicles that are travelling along the same route of the users. The users, for example, may be guided to move over a few lanes to the right if they are detected to be in the left lane, and the emergency vehicle is approaching in the left lane or left shoulder. In some implementations, the emergency vehicle may use a right shoulder or right lane, and the navigation system of a user may guide them to move a few lanes to the left prior to the emergency vehicle's approach. In another implementation, the emergency vehicle may be travelling in a center lane, and a navigation platform may guide some users in the center lanes to move left, and others to move right to avoid congestion on any one side of the roadway.

Accordingly, systems and methods are described herein for providing occupant and lane sensitive navigation. In an exemplary implementation, the disclosed systems and methods retrieve information relating to a plurality of road segments including a route between a start location of a vehicle and a destination of the vehicle. In some implementations, such information is retrieved from a database. The disclosed systems and methods determine a first travel duration for the vehicle to travel from the start location to the destination along the route. The disclosed systems and methods additionally determine whether any road segments of the plurality of road segments include restricted lanes having an occupancy-based restriction. In response to determining that at least one road segment of the plurality of road segments includes a restricted lane having an occupancy-based restriction, the systems and methods disclosed herein determine whether a number of occupants of the vehicle meets or exceeds the occupancy-based restriction. In response to determining that the number of occupants of the vehicle does not meet the occupancy-based restriction, the systems and methods disclosed herein display navigational directions from the start location to the destination that do not include the restricted lane. In some implementations, the navigational directions are displayed on a user equipment device. In response to determining that the number of occupants of the vehicle meets or exceeds the occupancy-based restriction, the systems and methods herein include determining whether a second travel duration for the vehicle to travel from the start location to the destination using the restricted lane is shorter than the first travel duration. In response to determining that the second travel duration is shorter than the first travel duration, the systems and methods herein display navigational directions from the start location to the destination that include the restricted lane. In some implementations, the navigational directions from the start location to the destination that include the restricted lane are displayed on the user equipment device. In response to determining that the second travel duration is not shorter than the first travel duration, the systems and methods herein navigational directions from the start location to the destination that do not include the restricted lane. In some implementations, the directions are displayed on a user equipment device.

In some exemplary implementations, the number of occupants of the vehicle is determined based on information received from a sensor of the vehicle. In other exemplary implementations, the number of occupants of the vehicle is determined based on user input received from a user input device.

In some exemplary implementations, the user equipment device is a cellular telephone. In other exemplary implementations, the user equipment device is an infotainment system of the vehicle. In yet other exemplary implementations, the user equipment device is a switchable transponder.

In certain exemplary implementations, the systems in methods herein also determine whether any road segments of the plurality of road segments include toll restricted lanes having a toll-based restriction. In response to determining that at least one road segment of the plurality of road segments includes a toll restricted lane having the toll-based restriction, the systems and methods herein determine whether a third travel duration for the vehicle to travel from the start location to the destination using the toll restricted lane is shorter than the first travel duration. In response to determining that the third travel duration is shorter than the first travel duration, the systems and methods herein display navigational directions from the start location to the destination that include the toll restricted lane. In response to determining that the third travel duration is not shorter than the first travel duration, the systems and methods herein display navigational directions from the start location to the destination that do not include the toll restricted lane. In some implementations, the navigational directions are displayed at the user equipment device. In some implementations, displaying navigational directions from the start location to the destination that include the toll restricted lane is further based on a user profile associated with the user equipment device.

In another exemplary implementation of the present disclosure, the systems and methods herein receive a plurality of vehicle speeds, each vehicle speed of the plurality of vehicle speeds corresponding to a vehicle associated with a respective user equipment device. In some implementations, such information is received from a plurality of user equipment devices. In some implementations, each vehicle of the plurality of vehicles is travelling on a roadway comprising a first lane and a second lane. The systems and methods herein group the plurality of vehicle speeds into a first group of vehicles and a second group of vehicles. The systems and methods herein determine a first average speed corresponding to the average speed of the first group of vehicles. The systems and methods herein determine a second average speed corresponding to the average speed of the second group of vehicles. The systems and methods herein determine whether the first group of vehicles is associated the first lane, and the second group of vehicles is associated with the second lane. In some implementations, such determination is based on the first average speed and the second average speed. In some exemplary implementations, the first average speed is lower than the second average speed. The systems and methods herein display navigational directions that include the second lane. In some implementations, the navigational directions are displayed at a user equipment device.

In some exemplary implementations, the systems and methods herein receive a plurality of vehicle locations. In some implementations, such information is received from the plurality of user equipment devices. In some implementations, each vehicle location of the plurality of vehicle locations corresponds to a vehicle of the plurality of vehicle locations associated with a respective user equipment device of the plurality of user equipment devices. In some implementations, determining that the first group of vehicles is associated the first lane, and the second group of vehicles is associated with the second lane is further based on the received vehicle locations.

In some exemplary implementations, the systems and methods further determine whether an emergency vehicle is travelling in the second lane. In such implementations, the systems and methods may display navigational directions that include the first lane.

In some exemplary implementations, the systems and methods further determine that an emergency vehicle is travelling in the first lane. In such implementations, the systems and methods herein display navigational directions that include the second lane. In some implementations, such information is displayed at a user equipment device.

### BRIEF DESCRIPTION OF THE DRAWINGS

The above and other objects and advantages of the disclosure will be apparent upon consideration of the following detailed description, taken in conjunction with the accompanying drawings, in which:

FIG. 1 depicts an illustrative process of a system for occupant and lane sensitive navigation, in accordance with embodiments of the disclosure;

FIG. 2 depicts an illustrative diagram of a system for occupant and lane sensitive navigation, in accordance with embodiments of the disclosure;

FIGS. 3A-3D depict illustrative diagrams of a system for occupant and lane sensitive navigation, in accordance with embodiments of the disclosure;

FIG. 4 depicts an illustrative diagram of a system for occupant and lane sensitive navigation, in accordance with embodiments of the disclosure;

FIGS. 5A and 5B depict illustrative diagrams of a system for occupant and lane sensitive navigation, in accordance with embodiments of the disclosure;

FIG. 6 depicts an illustrative diagram of a system for occupant and lane sensitive navigation, in accordance with embodiments of the disclosure;

FIG. 7 depicts an illustrative diagram of a system for occupant and lane sensitive navigation, in accordance with embodiments of the disclosure;

FIG. 8 depicts an illustrative diagram of a system for occupant and lane sensitive navigation, in accordance with embodiments of the disclosure;

FIG. 9 depicts an illustrative diagram of a system for occupant and lane sensitive navigation, in accordance with embodiments of the disclosure;

FIGS. 10A-10D depict illustrative diagrams of a system for occupant and lane sensitive navigation, in accordance with embodiments of the disclosure;

FIGS. 11A-11C depict an illustrative process of a system for occupant and lane sensitive navigation, in accordance with embodiments of the disclosure; and

FIG. 12 depicts an illustrative diagram of a system for occupant and lane sensitive navigation, in accordance with embodiments of the disclosure.

### DETAILED DESCRIPTION

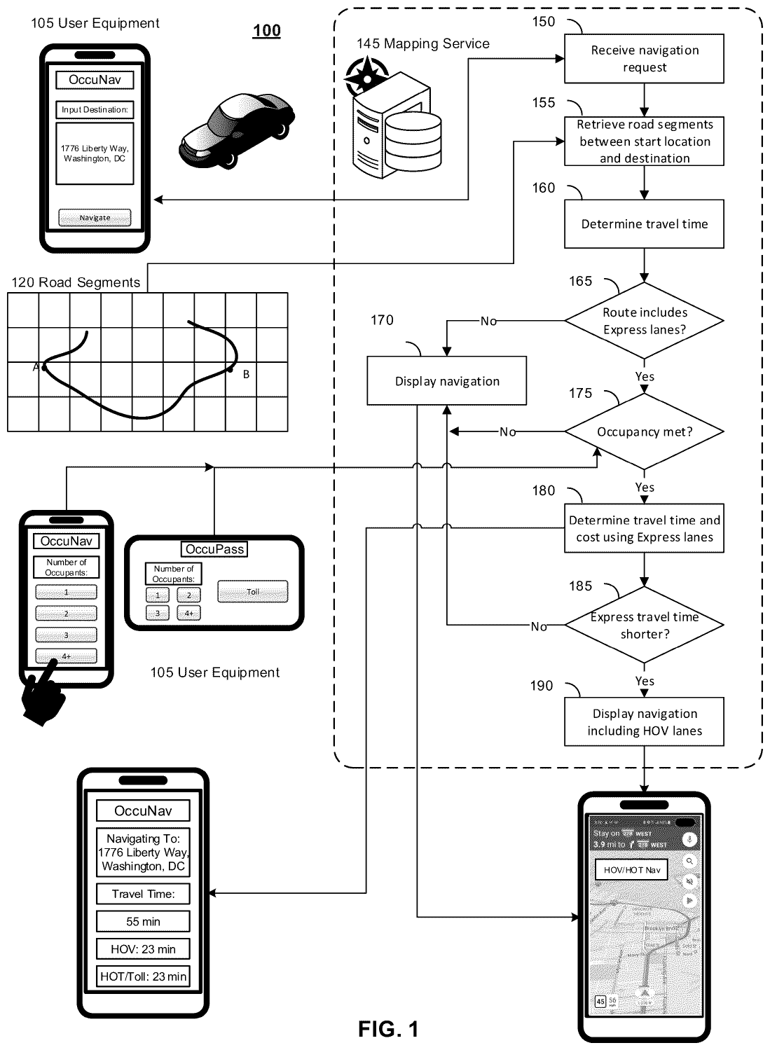

FIG. 1 illustrates an exemplary process of occupant and lane sensitive navigation, according to various embodiments of the present disclosure. At 150, process 100 receives a navigation request. In some embodiments, the navigation is received from user equipment 105. Although user equipment 105, 905, 1005, 1205 may be illustrated and described as a cellular telephone, user equipment 105, 905, 1005, 1205 may be embodied by any device sufficiently capable of implementing the techniques discussed herein. For example, user equipment 105 may be a cellular telephone, a tablet, a laptop computer, a computer, a smartwatch (or other wearable technological device), a toll transponder, a standalone navigation system, or a navigation system attached to or built in to a vehicle (e.g., a vehicle navigation system or an infotainment system), without departing from the contemplated embodiments. In some embodiments, navigation requests are maintained in a database, each associated with unique identifiers (for the vehicles, the navigation requests, or both). In this way, system 100 is able to group navigation requests and/or the vehicles associated therewith to implement features of the present disclosure.

At 155, system 100 receives information related to road segments between the start location and the destination. In some embodiments, system 100 retrieves road network information related to routes between the start location and destination. In some embodiments, such road network information is a data structure that represents a graph, e.g., road segments 120. Such embodiments are scalable for route computation. In some embodiments, road segments 120 are stored on a database included at mapping service 145. In other embodiments, road segments 120 are stored at a database that is remote from mapping service 145, for example, third-party navigation and/or mapping services. In yet other embodiments, road segments 120 are stored at user equipment 105.

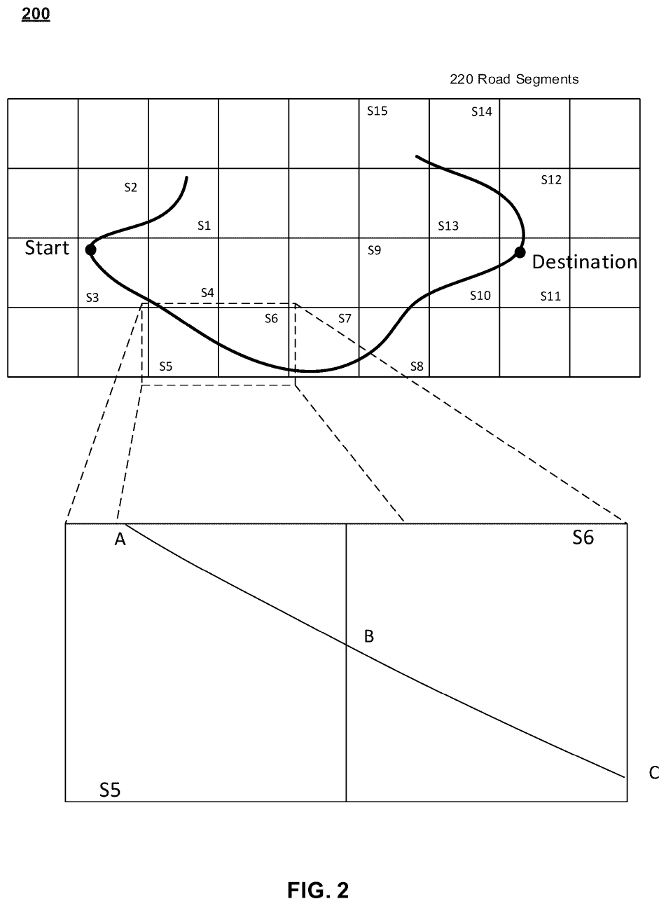

At 160, system 100 determines the travel time from the start location to the destination. In some embodiments, road networks are divided into segments that represent unit areas on a map. These segments have ingress and egress points that may be represented by smaller, more granular graphs with edges that have weights. The weights represent the edge properties such as time to traverse, average speed, distance, total toll fees of determined routes, etc. Multiple segments can also be coalesced into a “mega-segment” for ease of data representation and route computation. Such segments or “calculated paths” in each segment are stored in temporary or permanent memory for ready recall in route calculation and search. Such segments and applications thereof are discussed in further detail herein, for example, with respect to FIG. 2.

At 165, system 100 determines whether the determined route includes Express lanes (i.e., HOV, HOT, or toll restricted lanes). To simplify FIG. 1, it is presented in the context of Express lanes. Although the process discussed with respect to FIG. 1 is illustrated and described in the context of Express lanes, the techniques described herein are specifically applicable to HOV-only, HOT, or toll-only lanes, without departing from the contemplated embodiments. After determining the relevant segments based on termination conditions, system 100 determines whether an Express lane or road exists within that route. In some embodiments, such information is retrieved from a database, e.g., at mapping service 145. If system 100 determines there are no Express roads/lanes along the route, system 100 proceeds to 170 where navigation directions are displayed. However, if system 100 determines that the determined route includes Express lanes/roads, system 100 proceeds to 175.

At 175, system 100 determines whether the vehicle occupancy meets any of the criteria for using lanes/roads with occupancy-based restrictions (i.e., HOV and HOT lanes) such that a reduced toll or toll-free transport, or a reduced travel time is possible. In embodiments where the Express lane/road does not have an occupancy-based restriction (e.g., toll-only lane), step 175 may be skipped and process 100 proceeds from step 165 to 180. In some embodiments, the number of occupants is input at a user device, e.g., user equipment 105. In other embodiments, the number of occupants is determined by the system. For example, system 100 determines the presence of occupants from, for example, seat belts or other sensors used to, e.g., implement safety features of the vehicle (e.g., airbags). In the event that system 100 determines that occupancy requirements are not met, system 100 proceeds to 170. In the event that system 100 determines that the occupancy requirements are met, system 100 proceeds to 180.

At 180, system 100 determines the travel time using Express lanes. In an exemplary embodiment, system 100 determines differentiated speeds for the Express lanes from the unrestricted lanes. Based on determining whether the occupancy criteria are met, the system uses the Express lane average lane speeds or unrestricted lane average speeds, respectively to determine the time to traverse the road sections in that segment. In some embodiments, the real-time lane speeds are determined and kept in a database that is accessible to navigational systems. Additionally, some navigational services determine and track average lane speeds and such information may be used at step 160 and/or step 180. Alternatively, system 100 uses historical data to determine lane speed and travel time. In some embodiments, system 100 uses both real-time and historical information to determine lane speed and travel time. Such traversal times based on the differentiated speeds of Express, or unrestricted lanes are applied as the weights of the edges representing these roads. In embodiments where the user opts to incur toll payments, system 100 applies time traversal in an HOT/toll lane as the edge weight. If not, system 100 may default to time traversal in unrestricted lanes. Similarly, if HOT/toll lanes are contained in a segment, system 100 calculates differentiated speeds of the HOT/toll lanes from the unrestricted lanes and applies edge weights based on traversal time in the HOT/toll lanes if tolls are allowed, or traversal time in the unrestricted lanes if tolls are to be avoided/not allowed.

At 185, system 100 determines whether travel times are shorter using Express lanes as compared to travelling using “regular” (i.e., unrestricted) lanes. If system 100 determines that traveling from the start location to the destination using Express lanes is not shorter, system 100 proceeds to 170, where navigational directions are displayed at a user equipment device. In the event that system 100 determines that travel times using Express lanes is shorter as compared to unregulated lanes, system 100 proceeds to 190.

At 190, system 100 displays navigational directions from the start location to the destination using the Express lanes.

In another exemplary embodiment of the president disclosure and with reference to FIG. 2, system 200 determines travel time along the route using unrestricted lanes and HOV/HOT/Toll lanes, if any are determined to be co-located with the route. In an embodiment, system 200 retrieves user configured options. For example, whether the user elects to minimize time to destination at the expense of tolls or whether the user elects to avoid tolls, even if doing so prolongs the journey. In other embodiments, the user may opt to minimize the route time subject to a maximum cumulative tolls. In other embodiments, users may select a maximum allowable toll to be spent during the route. In such an embodiment, system 200 optimizes the route using toll and unrestricted lanes to minimize the travel time without exceeding the user-specified maximum allowable toll.

In another embodiment, system 200 retrieves road network information between the start and destination. In some embodiments, such information is retrieved as a data structure that represents a graph. In some embodiments, road networks are divided into segments that represent unit areas on a map.

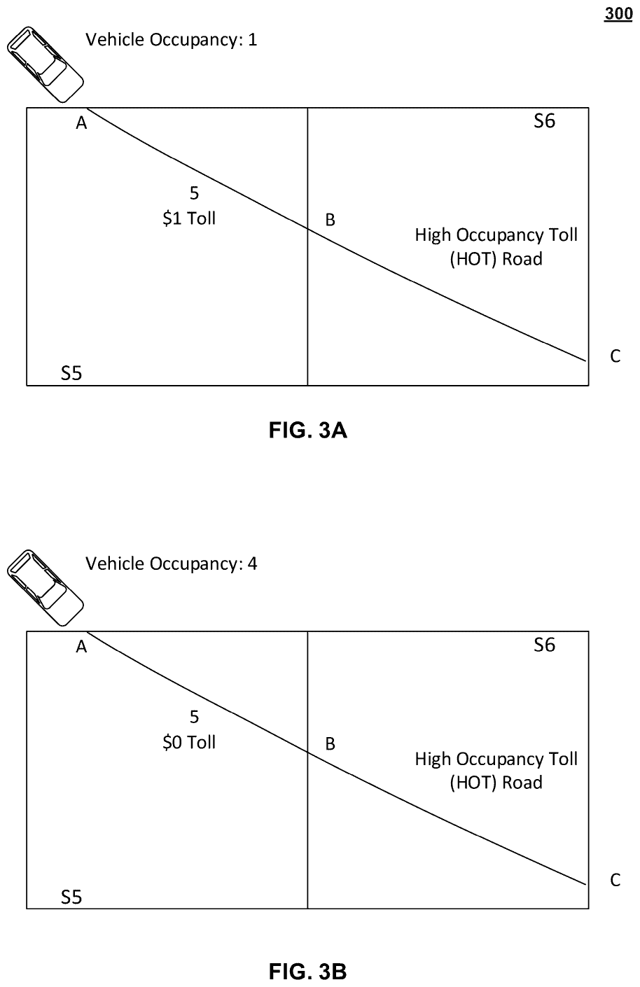

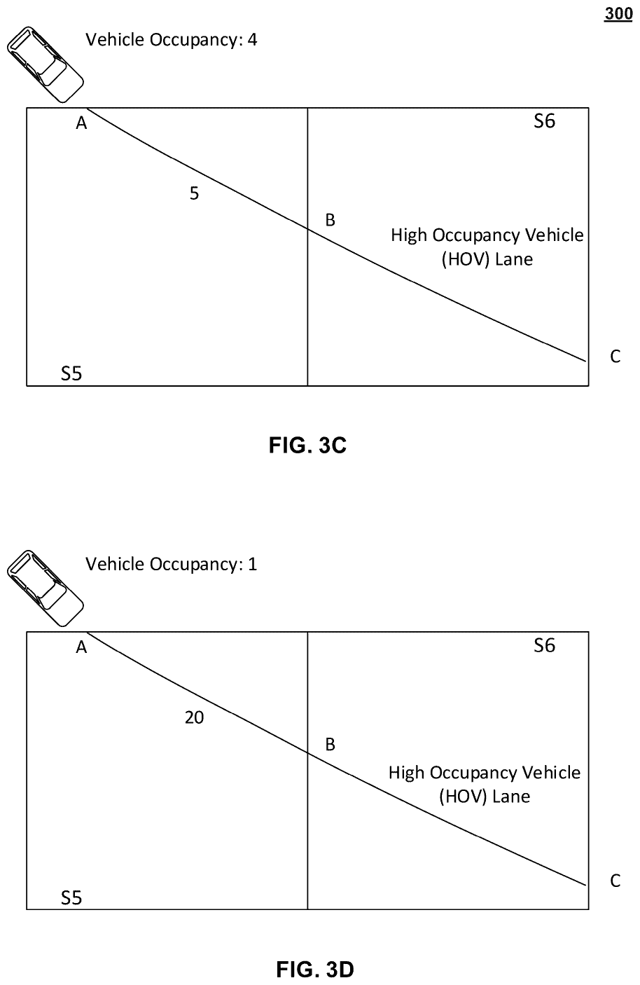

In an embodiment, system 200 applies weights that represent the edge properties such as time to traverse, average speed, distance etc. Multiple segments can also be coalesced into a “mega-segment” for ease of data representation and route computation. Although not illustrated with respect to FIG. 2, edge weights and other techniques for determining route traversal times are discussed herein, for example, with respect to FIG. 3.

As illustrated, road segments 220 include ingress and egress points A, B, and C and are represented by mini graphs with edges that have weights (not shown). In some embodiments, such road segments or “calculated paths” in each segment are stored for ready recall in route calculation/search. Although road segments 220 include 15 road segments, two segments-segments S5 and S6—are discussed for simplicity. Although certain techniques are illustrated and described with respect to road segments S5 and S6, such techniques are applicable to any or all of the illustrated road segments, without departing from the contemplated embodiments.

Based on the distance between the start point and destination, system 200 determines termination conditions for graph traversal using certain algorithmic techniques. For example, if the distance between the start and destination is 5 units, system 200 may set a termination condition maximum of 10 units of distance in any direction, thus restricting the number of segments to be considered relevant in the search.

After determining the relevant segments based on termination conditions, system 200 considers each relevant segment and determines whether a Toll/HOV/HOT lane or road exists in that segment. In some embodiments, such information is retrieved from a local or remote database. If there is no HOT/HOV road/lane, system 200 considers the next relevant segment. However, if an HOT/HOV lane/road exists in the segment, system 200 determines whether the vehicle occupancy meets any of the criteria for use of the HOT/HOV lanes/road such that a reduced toll or toll-free transport, or a reduced travel time. In such embodiments, system 200 determines vehicle occupancy by user input or by detecting the presence of occupants in the vehicle.

System 200 determines whether the HOT/HOV lanes/roads and unrestricted lanes/roads occur parallel and adjacent to each other. If such roads/lanes are co-located, system 200 determines differentiated speeds for the express (HOV/HOT) lanes as compared to the unrestricted lanes. System 200 uses the HOT/HOV average lane speeds or unrestricted average lane speeds, respectively, to determine the time to traverse the road sections in that segment based on whether the occupancy criteria are met. These traversal times based on the differentiated speeds of HOT/HOV, or unrestricted lanes are applied as the weights of the edges representing such roads/lanes. If the user has specified that toll payments are allowed (e.g., as indicated by a user profile), system 200 applies time traversal in an HOT/toll lane as the edge weight. For example, system 200 may apply time traversal in HOT/Toll lanes as the edge weight after determining whether the occupancy criteria is met. If the occupancy criteria is met, system 200 may represent the edge weight as zero-toll to the underlying route calculation algorithm. Otherwise, system 200 may compare the routes obtained using differentiated speeds on toll lanes as compared to unrestricted lanes and present the one or more routes ranked based on user preferences or other criteria. In some embodiments, system 200 defaults to time traversal in unrestricted lanes if the user indicates that the tolls are to be avoided.

In embodiments where system 200 determines that toll lanes are contained in a segment, system 200 calculates differentiated speeds of the toll lanes from the unrestricted lanes. In such embodiments, system 200 applies edge weights based on traversal time in the toll lanes.

After system 200 adjusts the weights for all relevant segments, system 200 inputs the graph to a traversal and search algorithm to generate recommended route(s). Edges associated with tolls in a segment may be “marked” or represented separately than edges that are associated with unrestricted lanes. System 200 determines suitable disposition of these edges for calculating the route and, in some embodiments, such determination is based on user preferences. In some embodiments where the user has configured the navigation system to avoid tolls, only the edges that are not associated with toll are input to the search algorithm. In some embodiments where system 200 is unable to find a solution based on user preference, system 200 applies a subsequent pass wherein the edges associated with toll lanes are considered.

In another exemplary embodiment of the present disclosure and with reference to FIGS. 3A-3D, system 300 applies weights to the retrieved road segments, e.g., road segments 220. FIGS. 3A-3D present examples illustrating how the weight of edges in a segment are modified based on vehicle occupancy, and how doing so affects the input to the search algorithm, according to certain embodiments of the present disclosure.

With reference to FIGS. 3A and 3B, a section of a road AB is running in segment S5. For simplicity, only a single road in the segment is illustrated, and directionally vehicles move from A to B. In the illustrated example of FIG. 3A, the road segment is a High Occupancy Toll (HOT) restricted road. As illustrated, the vehicle occupancy is 1 and the user would have to pay a $1 toll to use this road. Additionally, system 300 determines that it would take the vehicle 5 minutes to traverse this section (i.e., edge weight: 5). Similarly, and as illustrated in FIG. 3B, with a vehicle occupancy of 4, the user would not have to pay the toll and it would still take 5 minutes for the vehicle to traverse the road segment from A to B. In embodiments where the user has specifically configured the navigation system to avoid tolls, system 300 may not consider road segment AB in determining the travel time since its usage incurs tolls. However, although system 300 may not initially consider road segment AB in determining possible routes based on the user's preference to avoid tolls, system 300 may nevertheless consider road segment AB (as a toll road) when determining possible routes and associated travel times. Conversely, with a vehicle occupancy of 4 as illustrated in FIG. 3B, road segment AB would be considered by system 300, even though its weight has not changed since the vehicle occupancy meets the required occupancy and the vehicle is thus able to travel on road segment AB without incurring toll.

In another exemplary embodiment and with reference to FIGS. 3C and 3D, road segment AB represents a highway that includes both HOV and unrestricted lanes. As illustrated, system 300 determines the time to traverse AB in the HOV lane is 5 minutes (Edge weight: 5) and the time to traverse AB using unrestricted lanes is 20 minutes (Edge weight: 20). As illustrated in FIG. 3C, a vehicle with occupancy of 4 is shown and is thus eligible to use the HOV lane, resulting in an edge weight of 5 (e.g., 5 minutes to traverse road segment AB). However, as illustrated in FIG. 3D, a vehicle with occupancy of one is ineligible to use the HOV lane and thus incurs an edge weight of 20 (e.g., 20 minutes to traverse road segment AB using unrestricted lanes).

In some embodiments, system 300 may also use alternate methods to calculate optimal routes. For example, system 300 may initially consider edges that incur tolls even if the user has configured the system to avoid tolls, In such an embodiment, system 300 may modify the weights of such edges to increase the cost.

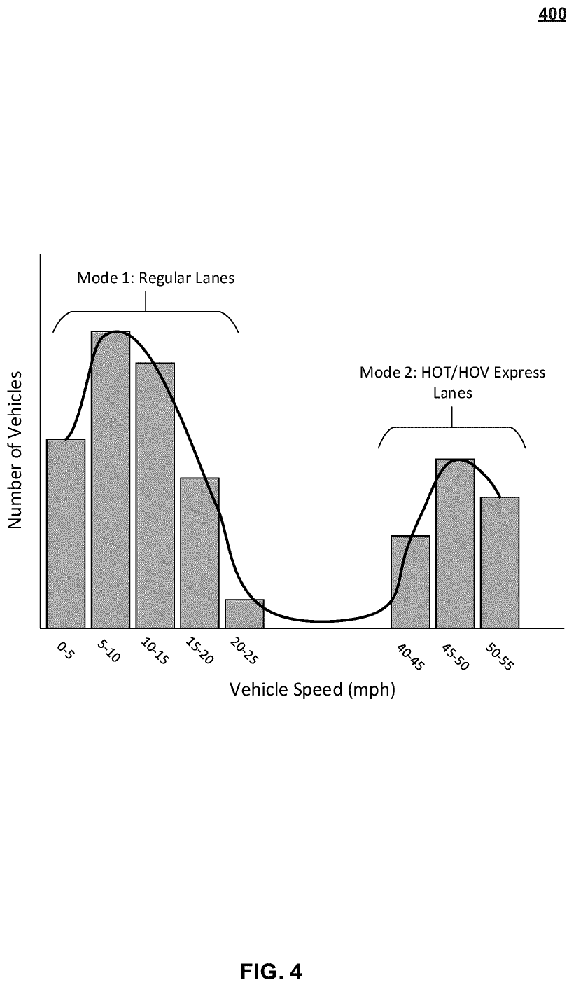

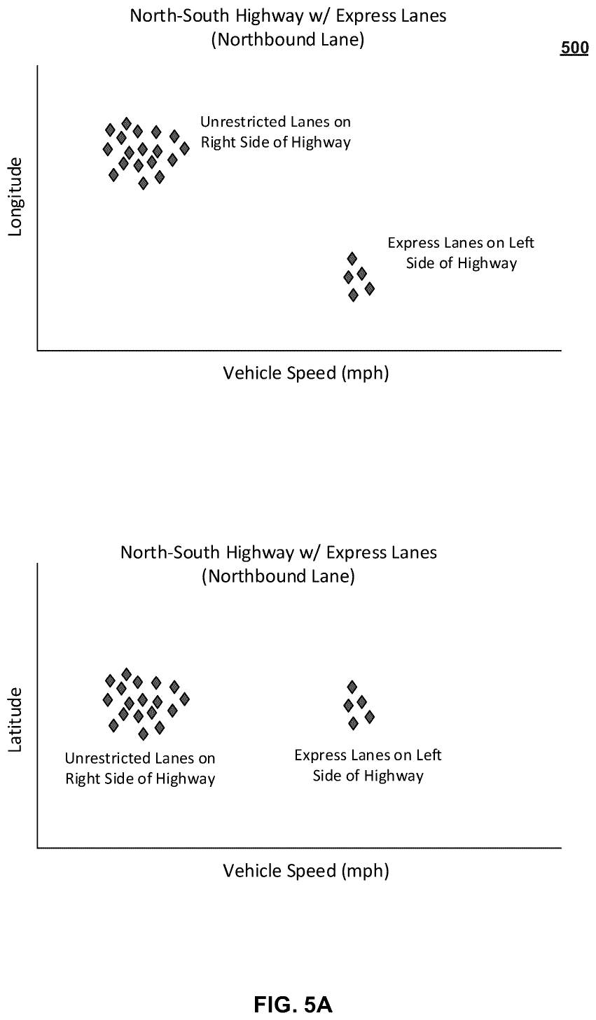

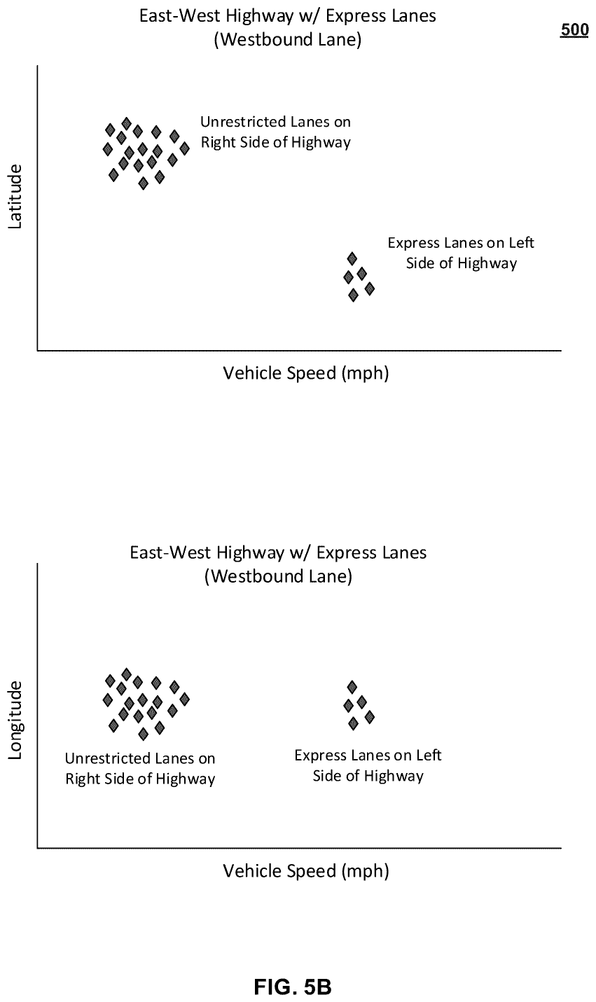

FIGS. 4 and 5 illustrate exemplary techniques for differentiating speeds of restricted and unrestricted lanes, according to various embodiments of the present disclosure.

In an exemplary embodiment of the present disclosure and with reference to FIG. 4, system 400 considers a distribution that includes volume of vehicles and their speeds as they traverse a road segment. As illustrated, a statistical distribution of a congested highway that includes unrestricted lanes and express (Toll/HOV/HOT) lanes in one direction illustrating a distribution of vehicles traveling from 0 to 55 miles per hour. In some embodiments, the unrestricted lanes of the highway move at a lower average speed than the express lanes. In such an embodiment, the distribution becomes bimodal. Mode 1 occurs at a lower speed with a higher peak for unrestricted lanes illustrating that more vehicles are moving a slower overall speeds. Conversely, mode 2 indicates that fewer vehicles are moving at higher speeds. In some embodiments, system 400 infers that mode 1 represents vehicles travelling in the unrestricted lanes while mode 2 represents vehicles travelling in the express lanes. In such an embodiment, system 400 infers that vehicles in the express lanes are less pronounced (typically lesser number of vehicles) and travel at higher speeds because there are fewer vehicles.

FIGS. 5A-5B illustrate cluster charts of vehicle speeds with latitude and longitude for North-South and East-West roadways respectively. Global Positioning Satellite (GPS) systems can measure coordinates within a range of a few meters using, for example, Circular Error Probability (CEP) in open sky conditions. Additionally, such GPS systems can measure speed with an accuracy at around 0.2-0.5 km/h.

In an embodiment, system 500 determines the speed of vehicles based on GPS information. In such an embodiment, express lanes typically lie to the left of unrestricted lanes. System 500 differentiates vehicles assigned to one mode of average vehicle speed from another mode of average vehicle speed using statistical techniques that consider latitude and longitude together with the vehicle speed.

In an exemplary embodiment and with reference to FIG. 5A, system 500 considers the northbound lane of a North-South highway (in the Eastern hemisphere). In such an example, vehicles in the express lane (left side) will report a slightly lower value of longitude than vehicles in the unrestricted lanes. In such an embodiment, there will be no discernible difference in the latitude of the two groups of vehicles because they are travelling northbound.

In another exemplary embodiment and with reference to FIG. 5B, in an embodiment examining an East-West highway (in the Northern hemisphere), the vehicles in the express lane on the left side of the highway will report a slightly lower value of latitude than vehicles in the unrestricted lanes. There will be no discernible difference in longitude between the two groups of vehicles because all will be travelling westbound. These differences in latitude, longitude, or both, indicate that the two groups of vehicles can be exploited in determining the differentiated average speeds in express and unrestricted lanes for a highway that runs in particular direction.

The techniques discussed with respect to FIG. 5 need not include the assumption that express lanes are typically located on a particular side of the roadway (e.g., on the left side of the roadway) because GPS coordinates are considered. In some embodiments, system 500 receives lane information indicating where on a particular roadway express lanes are located. In such an example, system 500 receives lane information from, for example, a local or remote database containing roadway information. Such information may be obtained from third party mapping platforms or other publicly available databases of express lane roadways. Using such information in conjunction with GPS information from vehicles travelling on the roadways enables system 500 to make multi-modal speed determinations while being able to discern in which lanes the respective vehicle modalities are travelling. In this way, system 500 differentiates the speed of vehicles travelling in express lanes (HOV, HOT, Toll) from those travelling in unrestricted (regular) lanes.

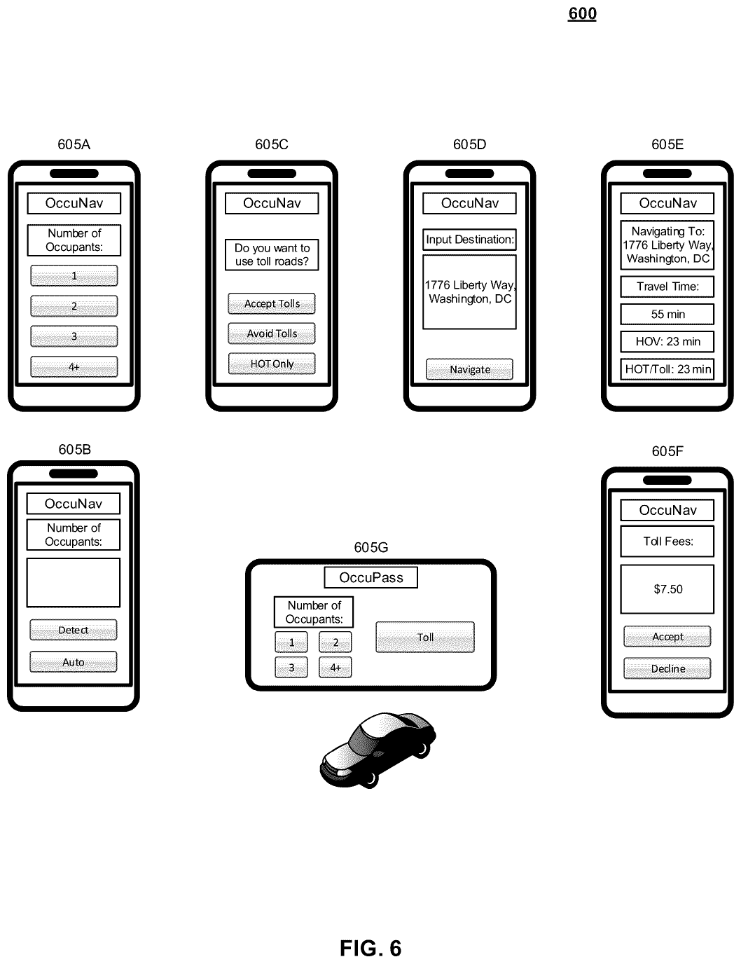

In another exemplary embodiment of the present disclosure and with reference to FIG. 6, system 600 includes a user interface (“UI”). Such UIs enable users to interact with system 600. For example, user interface 605A enables a user to select the number of occupants of the vehicle from a list; as illustrated, 1, 2, 3, or 4+ occupants. Although a specific number of occupants are listed among the user selectable elements, any number of occupants may be listed on user interface 605A without departing from the contemplated embodiments.

In another embodiment, user interface 605B enables the user to enter the number of occupants of the vehicle. Additionally, user interface 605B includes user selectable elements to engage in automatic detection of the number of occupants of the vehicle. As discussed herein, system 600 may, in some embodiments, determine the presence of occupants from, for example, seat belts or other sensors used to, e.g., implement safety features of the vehicle (e.g., airbags). In some embodiments, system 600 may determine the number of occupants based on weight sensors in each seat of the vehicle (i.e., number of occupied seats) or seatbelt clicks (i.e., number of engaged seatbelts). In other embodiments, an imaging camera, depth sensing camera, etc. are used to determine occupancy. In such embodiments, the system may monitor the image received and determine which seats have humans (using, e.g., facial or body features, and change in posture with time) versus some seats that have either inanimate objects or pets. In some embodiments, wireless presence detection techniques that rely on channel sounding may be used to detect the number of occupants. In other embodiments, system 600 may detect the number of personal devices such as smartphones or tablets that have short range RF transceivers (e.g., Bluetooth, UWB) using beaconing technology to estimate the number of occupants. Such devices may also be associated with user profiles and may be known to the vehicle's systems (e.g., a user profile stored at a local or remote database).

In another exemplary embodiment, user interface 605C includes user selectable elements that allow a user to specify whether to use toll roads. For example and as illustrated, user interface 605C includes user selectable element to accept tolls, avoid tolls, or use high occupancy toll lanes only. Although certain user selectable elements are illustrated and described with respect to user interface 605C, user interface 605C can have any type of user selectable element pertaining to any aspect of system 600, without departing from the contemplated embodiments.

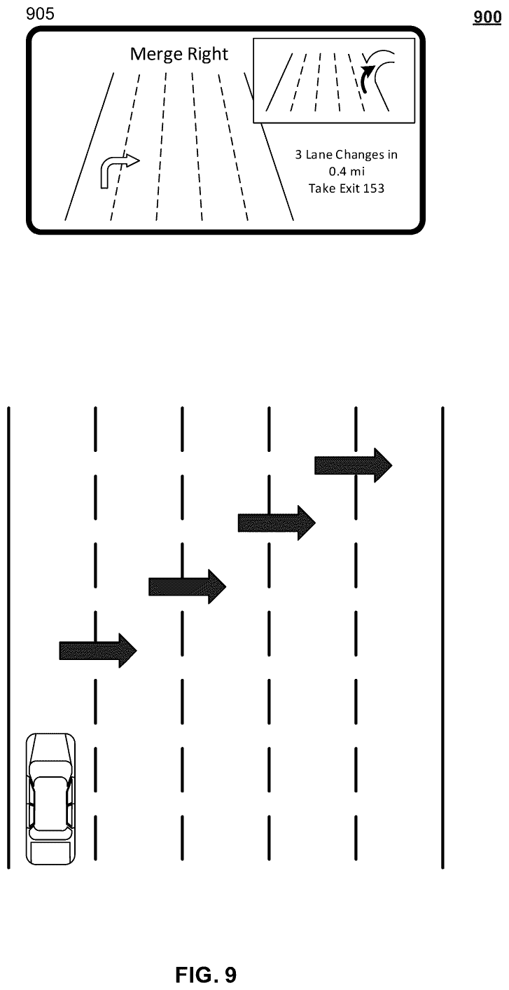

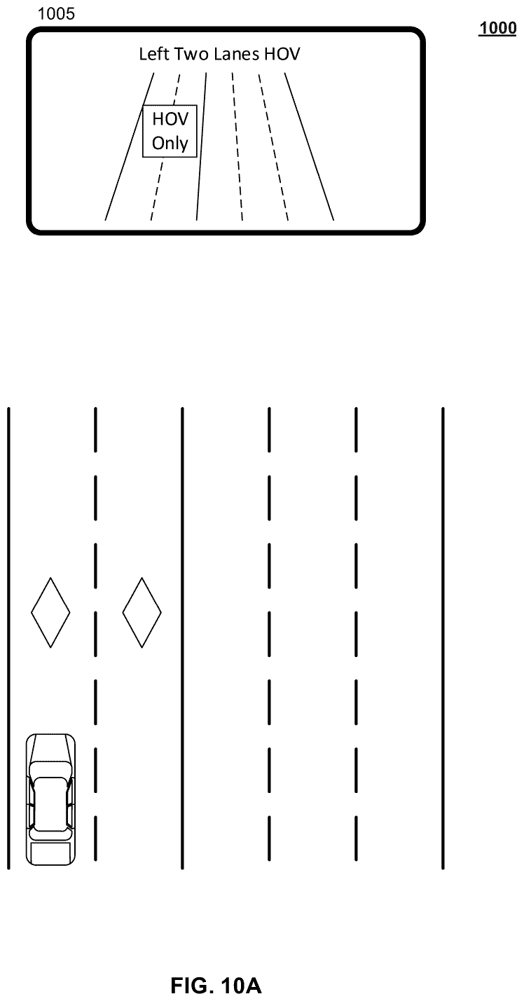

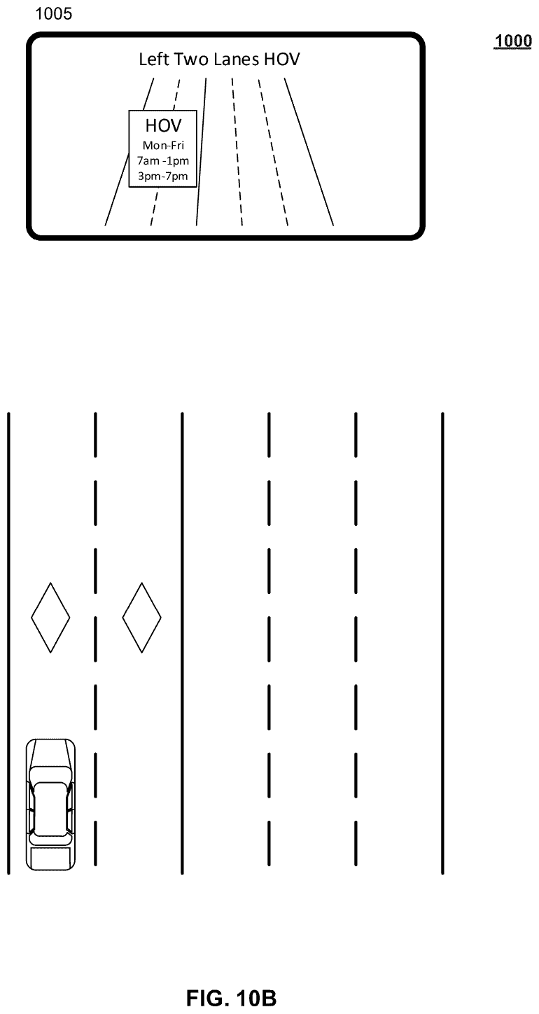

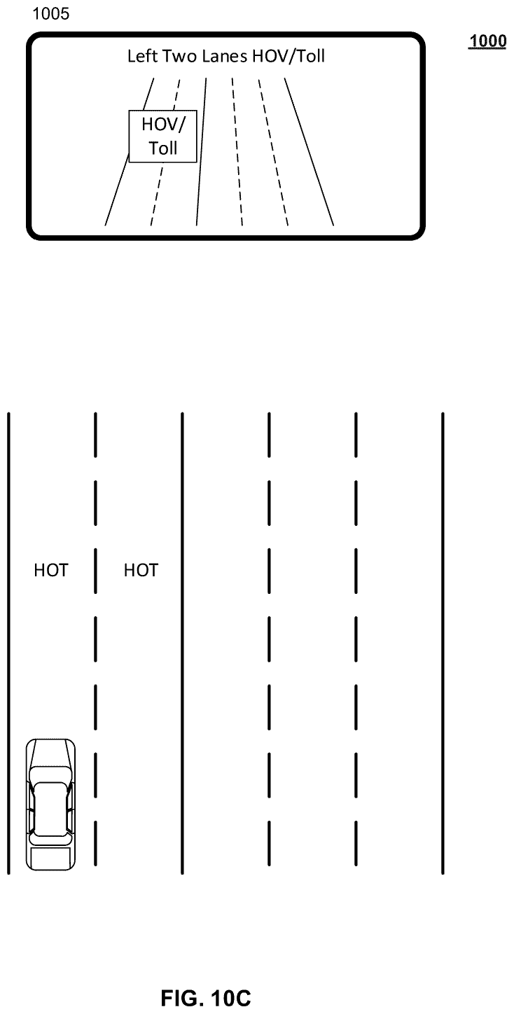

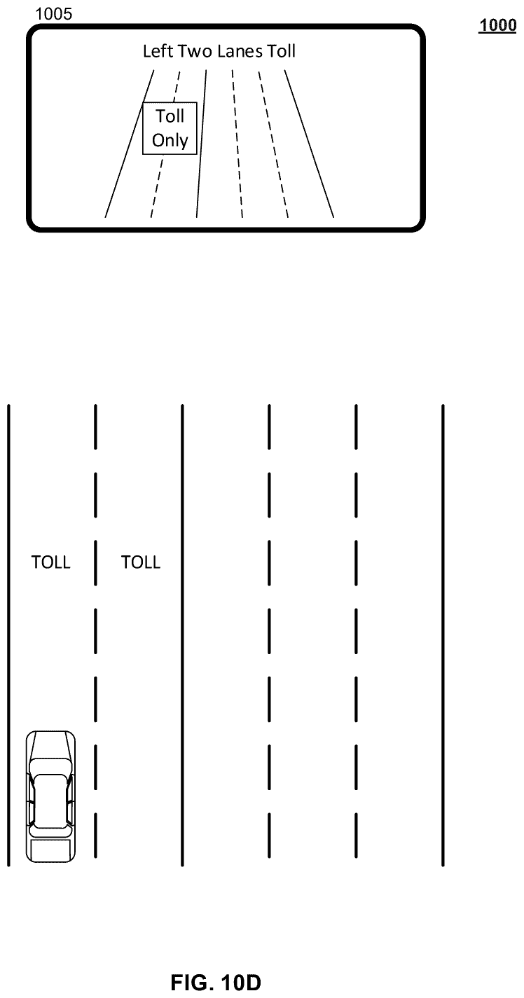

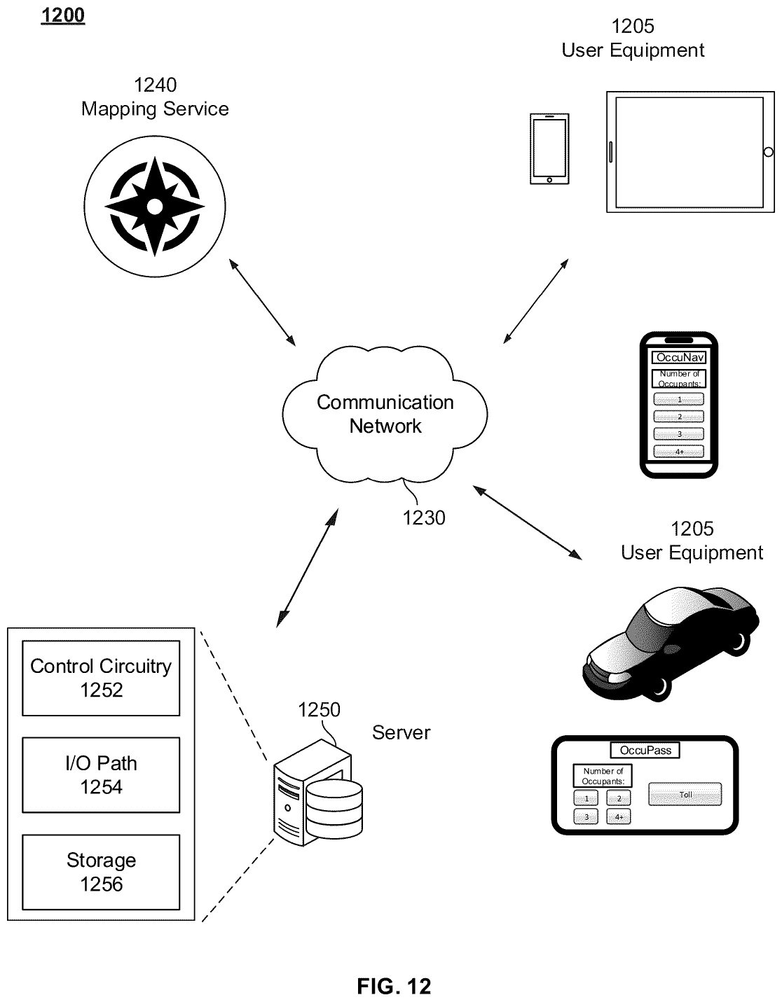

In another exemplary embodiment, system 600 includes user interface 605D. As illustrated, user interface 605D enables a user to input a destination obtain navigational directions. For example, a user can input the address of 1776 Liberty Way, Washington, DC to obtain directions to that location. In other embodiments, user interface 605D includes additional user selectable elements with which a user can obtain navigational directions. For example, user interface 605D may include a database of historical locations to which the user had previously navigated. In such an embodiment, user interface 605D includes an option to navigate to those locations. In other embodiments, user interface 605D includes predetermined or selected routes determined by either the user and/or system 600. Additionally, user interface 605D may include navigation directions associated with a user profile and/or the user equipment device (e.g., user equipment 105, 905 as discussed with respect to FIG. 9, 1005 as discussed with respect to FIG. 10, 1205 as discussed with respect to FIG. 12).

In another exemplary embodiment, system 600 includes user interface 605E. As illustrated, user interface 605E displays a navigational destination (for example, the destination input with respect to user interface 605D). As illustrated, user interface 605E displays a travel time of approximately 55 minutes that corresponds to the amount of time system 600 determined it will take the user to travel from its current location (or specified start location) to the destination using unrestricted lanes. Additionally, user interface 605E includes estimations for the time it will take to traverse from the user's current location (or a specified start location) to the destination using occupancy or toll restricted lanes. For example and as illustrated, user interface 605E displays a travel time of approximately 23 minutes using HOV lanes. Similarly, user interface 605E displays an estimated travel time of 23 minutes using HOT/toll roads. Although the estimated travel time displayed on user interface 605E is the same with respect to using HOV lanes and HOT/toll lanes, the estimated time may be different, without departing from the contemplated embodiments. In some embodiments, user interface 605E is displayed without system 600 determining the occupancy of the vehicle. In such an embodiment, system 600 determines travel times and differentiated speeds of Express lanes and unrestricted lanes without considering the occupancy of the vehicle.

In another exemplary embodiment, system 600 includes user interface 605F. As illustrated, user interface 605F displays an estimated toll that the user would have to pay to use the toll lanes that system 600 determined to be along the user's navigational route (or HOT lane where the vehicle does not meet the occupancy requirement for toll-free use). As illustrated, system 600 determines that using toll lanes to arrive at the input destination, the user will incur approximately $7.50 worth of tolls. In embodiments where system 600 determines that the route include a HOT lane and the occupancy requirement is met for toll-free use, system 600 may exclude toll fees. User interface 605F also includes user selectable elements that allow the user to accept the tolls or decline the tolls. In some embodiments, when the user accepts the toll fees, system 600 displays navigational directions from the user's current location to the input destination using the toll lanes. In other embodiments, the user can decline the tolls. In such an embodiment, system 600 may, for example, display navigational directions from the user's current location to the input destination using unrestricted toll lanes, thereby preventing toll incurrence.

In some embodiments, the user equipment device (e.g., user equipment 105 as discussed with respect to FIG. 1, 905 as discussed with respect to FIG. 9, 1005 as discussed with respect to FIG. 10, 1205 as discussed with respect to FIG. 12) is embodied by a dedicated transponder. In such an embodiment, user equipment device may display user interface 605G. As illustrated, user interface 605G includes user selectable elements. In some embodiments, the user selectable elements enable the user to input the number of occupants of the vehicle. In such an embodiment, system 600 uses such information to determine whether the vehicle meets the requirements to use HOV lanes. Additionally, user interface 605G may include a user selectable element that enables the user to incur tolls. In such an embodiment, the user can specify that they accept tolls, thereby being able to use HOT/toll lanes. In other embodiments, user interface 605G includes a display that indicates the amount of tolls incurred over the course of a trip. In other embodiments, user interface 605G may also display an amount of estimated tolls that the user will incur in making the trip.

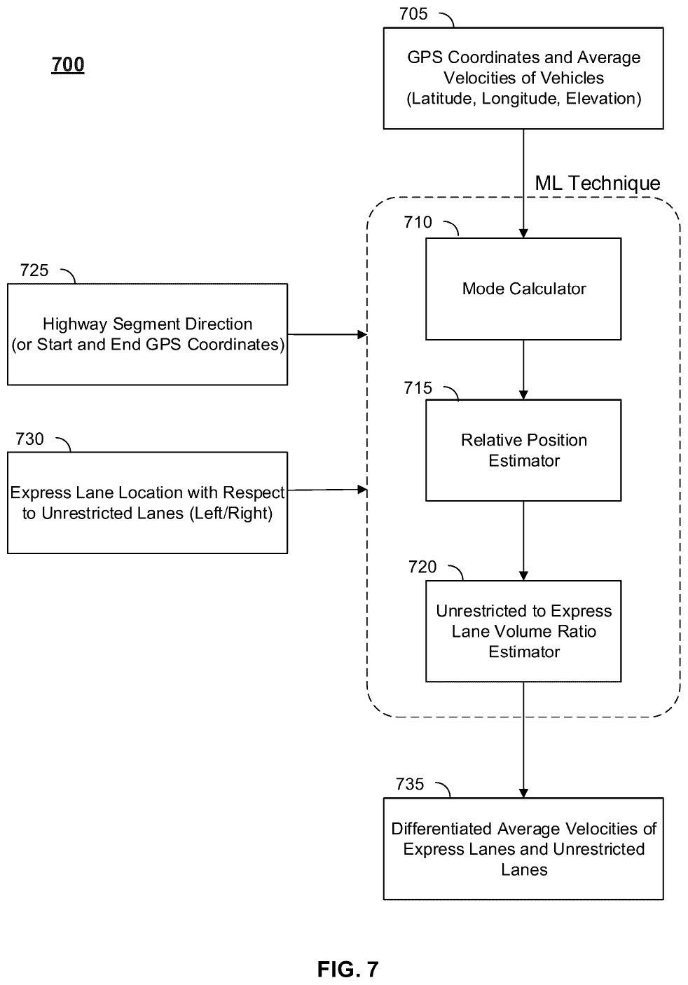

FIG. 7 illustrates an exemplary machine learning technique for calculating differentiated speeds for unrestricted and express lanes, according to embodiments of the present disclosure. As illustrated, machine learning technique includes mode calculator 710, relative position estimator 715, and unrestricted to express lane volume ratio estimator 720. At 705, system 700 receives GPS coordinates and average velocities of vehicles travelling along a roadway. In some embodiments, such information is stored at a database. For example, such information may be received from the third-party service providers that provide traffic information.

As illustrated, the ML technique uses various inputs to determine the differentiated average speeds of vehicles traveling in unrestricted and express lanes (i.e., HOV/HOT/toll lanes/roads). For example, at 725, system 700 uses highway segment direction or start and end GPS coordinates for particular segments of roadways on which the user is determined to travel. Additionally, at 730, the ML technique considers the express lane location relative to unrestricted lanes. For example, such input may include information indicating that the express lanes are located on the left side or on the right side of unrestricted lanes. Although not shown in FIG. 7, system 700 may consider inputs. For example, system 700 may consider the number of unrestricted lanes, the number of Express lanes, and special considerations such as gross vehicle weight ratings (GVWR) for commercial vehicles and roads having GVWR restrictions, vehicle or trailer size restrictions, and road feature information (e.g., roundabouts, road width, severity of turns/corners), without departing from the contemplated embodiments.

At 710, ML technique includes a mode calculator. Such an exemplary mode calculator determines the modes of average speeds for two groups of vehicles, i.e., unrestricted and express lanes. Such techniques are discussed herein, for example, those discussed with respect to FIGS. 4 and 5.

At 715, system 700 includes a relative position estimator. In some embodiments, system 700 uses the information determined at 710 to compute which mode of average speed is statistically more likely to represent the express lane based on the GPS coordinates of vehicles passing through the particular segment.

At 720, system 700 includes a volume ratio estimator. As illustrated, the unrestricted to express lane volume ratio estimator 720 estimates the number of express lanes to the number of unrestricted lanes using historical information. Such historical information can be stored in one or more databases that is local to, or remote from, system 700. In some embodiments, unrestricted to express lane volume ratio estimator 720 validates (or invalidates) the determinations of the relative position estimator 715. System 700 does so by, for example, determining whether the ratio of the volume of cars expected to travel on the segment using the unrestricted lanes to the express lanes at a particular location align with the determinations made at 715. In some embodiments, system 700 additionally or alternatively uses clustering to determine the differentiated speeds. In this way, system 700 determines differentiated average velocities of the express lanes (i.e., HOV/HOT/toll lanes/roads) to unrestricted lanes, in accordance with various embodiments of the present disclosure.

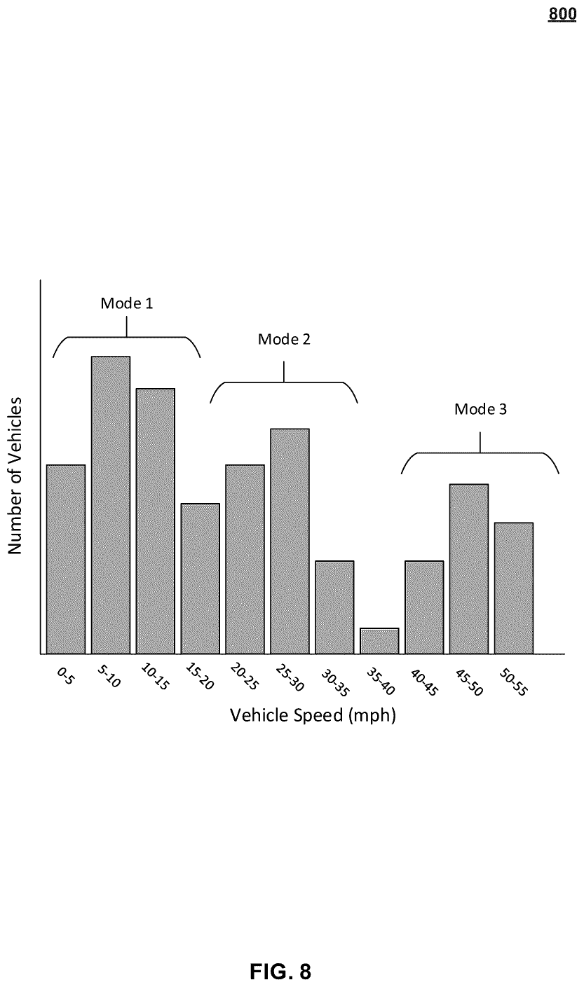

FIG. 8 illustrates an exemplary distribution of velocities of a congested road roadway with six to eight lanes, according to exemplary embodiments of the present disclosure. In an exemplary embodiment, calculating the distribution of velocities in addition to a relative position estimation (e.g., as discussed with respect to FIG. 7) helps localize vehicles to a lane, or groups of vehicles to adjacent lanes, depending on traffic conditions.

As illustrated, system 800 determines average velocities for three modes of vehicles. Mode 1 consists of vehicles traveling between 0 mph and 15 mph, Mode 2 consists of vehicles traveling from 15 mph to 30 mph, and mode 3 consists of vehicles traveling from 35 mph to 55 mph; with such modes peaking at around 7½ miles an hour, 27½ miles an hour, and 47½ miles an hour, respectively. Although the illustrated distribution includes 3 modes, any distribution with any number of modes may be implemented without the parting from the contemplated embodiments.

In another exemplary embodiment of the present disclosure and with reference to FIG. 9, system 900 displays navigational directions to a user that may include an indication of when to merge into or out of specific lanes. For example, system 900 displays recommendations to the user to begin merging over to a certain side of the highway or roadway when that user's exit is approaching. For example, system 900 indicates that the user should begin merging to the right because system 900 recommends that the user take exit 153 in 0.4 miles. In such an example, system 900 may identify that a user is travelling in the left-most lane of a highway. Based on the determined route, system 900 may determine that the user should take an exit by crossing 4 lanes to the right in the next 0.4 miles.

In other embodiments, system 900 recommends lane changes to the user to avoid congestion. In such an embodiment, system 900 may advise the user to change lanes to avoid upcoming congestion in a lane or multiple lanes that are upcoming along the user's route. Changing lanes ahead of congestion helps reduce lane changes required when the user reaches the congested segment and improves road safety. Providing such lane change suggestions may also reduce travel time for a user. In other embodiments, providing lane recommendations to multiple vehicles travelling on a road segment will help distribute traffic more evenly across lanes, thus helping to avoid congestion at all.

In another embodiment, system 900 recommends the user to change lanes to yield to incoming emergency vehicles that are determined to use the lane. In such an embodiment, system 900 receives an indication that an emergency vehicle is traveling on the same roadway as the user's vehicle. Additionally, system 900 receives information indicating which specific lane that the emergency vehicle is traveling in. With that information, system 900 may display recommendations to change lanes to avoid the emergency vehicle. For example, system 900 determines that an emergency vehicle is traveling along the same roadway in the leftmost lane. In such an example, system 900 displays recommendations to the user to merge out of the leftmost lane. In another embodiment, the emergency vehicle may use a right shoulder or right lane, and system 900 may guide the user to merge left prior to the emergency vehicle's approach. In another embodiment, the emergency vehicle may be travelling in a center lane, and system 900 may guide some users in the center lanes to merge left, and others to merge right, to avoid congestion on any one side of the highway while clearing the center lane for the emergency vehicle. In other embodiments, system 900 recommends that the user merge to the rightmost lanes, regardless of what lane the emergency vehicle is traveling in, thereby clearing the leftmost lane of all traffic.

In some embodiments, system 900 considers the emergency vehicle's anticipated route. In such an embodiment, system 900 may only alert vehicles travelling along the emergency vehicle's route. For example, system 900 may alert the presence of the emergency vehicle to vehicles travelling on a roadway up to an anticipated exit (or turn) of the emergency vehicle. In such an example, vehicles travelling on the same roadway after the emergency vehicle's anticipated exit need not be alerted because the emergency will not need to travel on that portion of the roadway. In this way, system 900 minimizes the emergency vehicle's impact on traffic.

FIGS. 10A-10D illustrate various lane configurations and navigational recommendations, according to various embodiments of the present disclosure. Various aspects of the present disclosure describe how differentiated velocities for the express lanes from the unrestricted lanes may be derived. Such differentiation may be used by system 1000 to calculate a more precise ETA or toll requirement as well as to guide a user on when and where to enter or exit an express lane or unrestricted lanes. In some embodiments, system 1000 may detect when the user has not moved into an express lane according to directions and update the navigation information. For example, system 1000 may recalculate the route ETA by changing the edge weight that represents the time spent in a differentiated HOV lane back to an edge weight that represents the time spent in an unrestricted lane (for example, as discussed with respect to FIGS. 2-3).

In an exemplary embodiment of the present disclosure and with reference to FIG. 10A, System 1000 determines that the two most lanes are HOV lanes. As discussed herein, system 1000 provides navigational directions for the user including occupancy based restrictions. For example, system 1000 provides navigational directions to the user that include the HOV lanes when system 1000 determines at the vehicle occupancy requirement is met. As illustrated, system 1000 determines that 3 users occupy vehicle and thus the vehicle qualifies for to travel in the HOV lanes.

In another exemplary embodiment of the present disclosure and with reference to 10B, system 1000 determines that the leftmost 2 lanes are HOV lanes. As illustrated, the HOV lanes are temporary HOV lanes and they're only restricted between the hours of 7:00 AM and 1:00 PM and 3:00 PM and 7:00 PM Monday through Friday. In the event that the vehicle travels along this roadway outside of the restricted hours, all five lanes function as unrestricted lanes. In the event that system 1000 provides navigational directions to the user during the restricted time periods, system 1000 determines the occupancy of the vehicle to determine whether the vehicle qualifies to use the HOV lanes. In the illustrated example, system 1000 uses the time of travel as an input when determining whether vehicle meets occupancy based restrictions for using HOV lanes.

In another exemplary embodiment of the present disclosure and with reference to FIG. 10C, system 1000 determines that the leftmost 2 lanes are high occupancy toll lanes. In such an embodiment, system 1000 determines the occupancy of the vehicle to determine whether the vehicle qualifies to use the high occupancy toll lanes without having to pay the toll. In the event that system 1000 determines that the occupancy based restriction is met, system 1000 determines that the vehicle will not have to pay a toll to travel in the high occupancy toll lane. Conversely, in the event that system 1000 determines that the occupancy based restriction is not met, system 1000 displays navigational directions to the user that include toll lanes and provides an option to the user to accept tolls. If the user declines to use the toll road, system 1000 displays navigational directions to the user that do not include the toll lane.

In another exemplary embodiment of the present disclosure and with reference to FIG. 10D, system 1000 determines that the leftmost 2 lanes are toll lanes. In such an embodiment, system 1000 displays options to the user to accept the tolls or decline the tolls. If the user accepts the tolls, system 1000 displays navigational directions to the user that include the toll lanes (in the event that using such lanes will decrease the user's travel time).

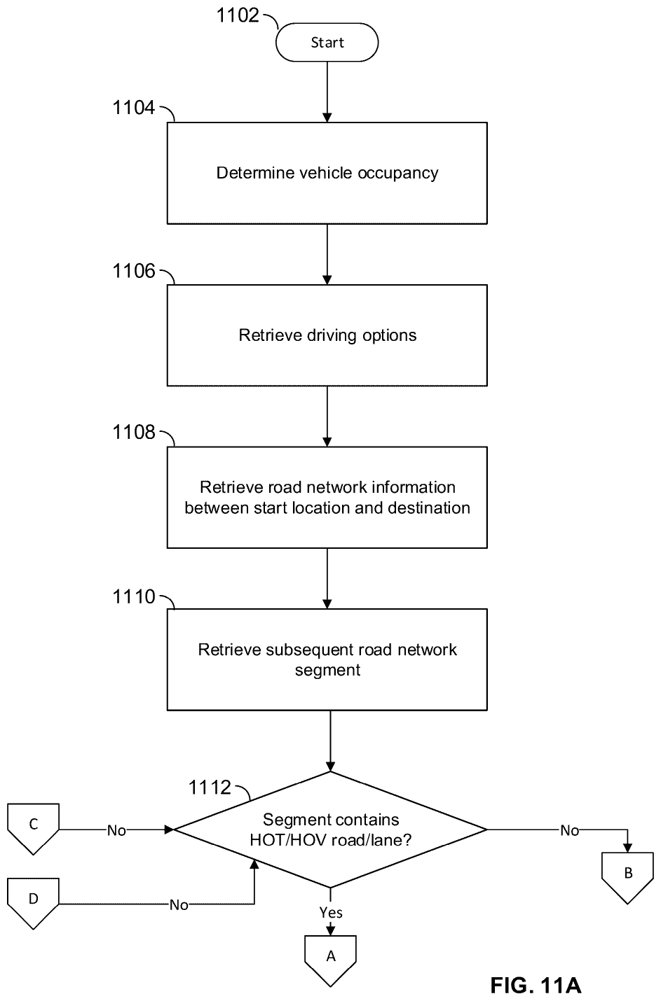

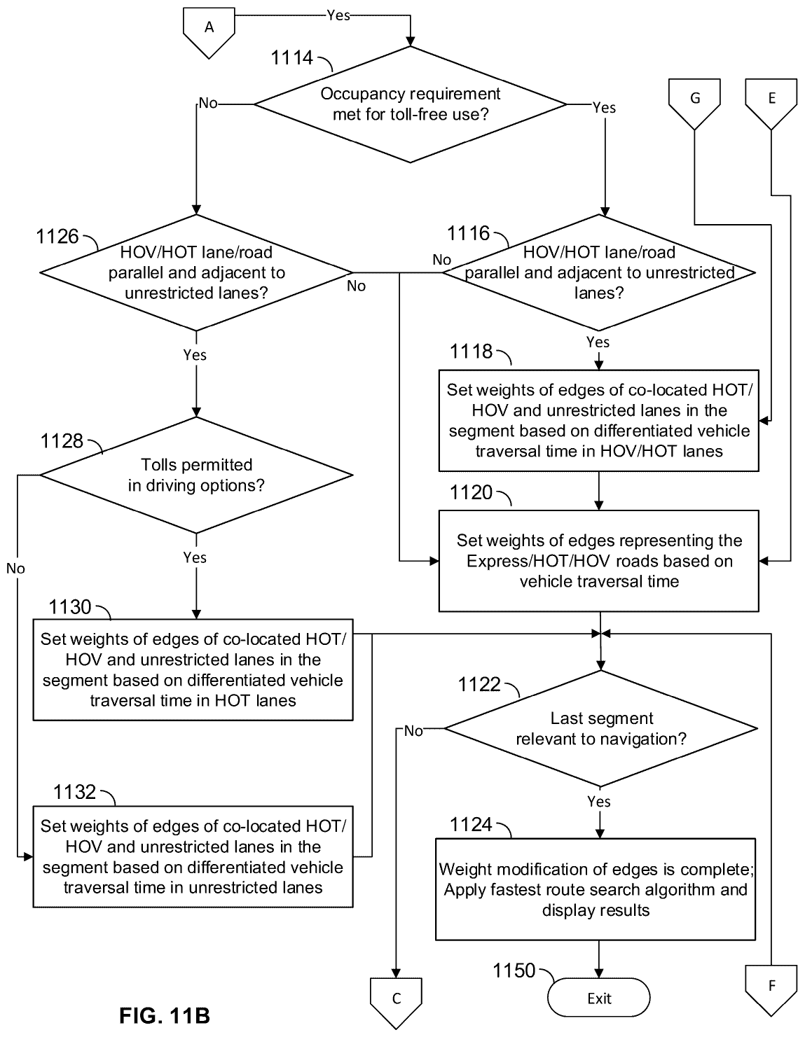

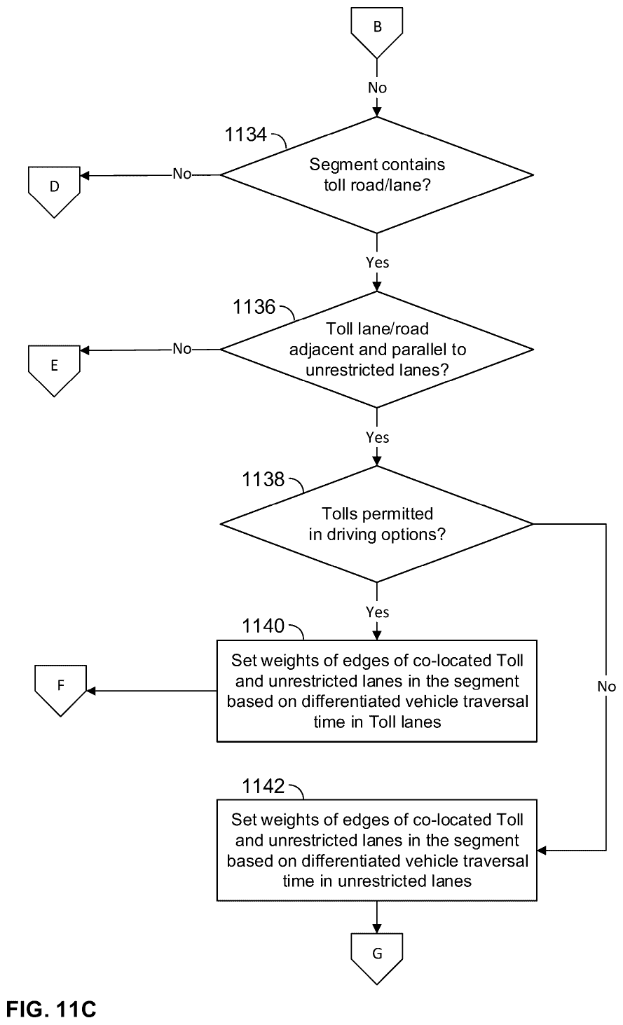

In another exemplary embodiment of the present disclosure and with reference to FIGS. 11A-11C, system 1100 provides occupant and lane sensitive navigation. At 1102, system 1100 initializes. In some embodiments, system 1100 initializes when a user input is received. For example, system 1100 initializes when a user engages the system by, e.g., opening an application on a mobile device or other user equipment device (e.g., user equipment 105 as discussed with respect to FIG. 1, 905 as discussed with respect to FIG. 9, 1005 as discussed with respect to FIG. 10, 1205 as discussed with respect to FIG. 12). In another embodiment, system 1100 automatically initializes. In such embodiments, system 1100 may initialize when a vehicle is powered on or started. In another embodiment, system 1100 automatically initializes when the user requests navigational directions via, e.g., a local navigation application or a third-party navigation application. In another embodiment, system 1100 initializes when the user equipment device detects that the user equipment or the user's vehicle it's traveling on a roadway that includes an HOV/HOT/Toll lane.

At 1104, system 1100 determines vehicle occupancy. In some embodiments, determining occupancy is achieved by user input via a user equipment device, e.g., a consumer device application (when using a personal device navigation system that is separate from the vehicle navigation system) or using the in-vehicle navigation system or infotainment system. In some embodiments, the vehicle navigation system may also calculate the number of occupants based on weight sensors in each seat of the vehicle (i.e., number of occupied seats) or seatbelt clicks (i.e., number of engaged seatbelts). In other embodiments, an imaging camera, depth sensing camera, etc. are used to determine occupancy. In such an embodiment, system 1100 may monitor the image received and determine which seats have humans (using, e.g., facial or body features, and change in posture with time) versus some seats that have either inanimate objects or pets. In some embodiments, wireless presence detection techniques that rely on channel sounding may be used to detect the number of occupants. In other embodiments, the system may detect the number of personal devices such as smartphones or tablets that have short range RF transceivers (ex., Bluetooth, UWB) using beaconing technology to determine the number of occupants. Such devices may also be associated with user profiles and may be known to the vehicle's systems (e.g., a user profile stored at a local or remote database). The contemplated embodiments of the present disclosure may use any combination of the above, and in some embodiments, seek confirmation of the number of occupants from the driver or car occupants using an interface such as an LCD screen or voice assistant/NLP.

At 1106, system 1100 retrieves driving options. In some embodiments, user preferences (including driving options) are stored at a local or remote database. Such preferences are used to calculate and determine route solutions including route optimization, i.e., the route search. For example, whether the user desires to minimize time to destination at the expense of tolls, whether the user desires to avoid tolls even if doing so results in a later ETA, or whether the user desires to minimize the route time subject to a maximum cumulative toll fee.

At 1108, system 1100 retrieves road network information between the start location and the destination. In some embodiments, system 1100 also receives a request for navigational directions that include a start location and a destination. In some embodiments, system 1100 additional information along with the request for navigation. For example, system 1100 may additionally receive an indication that the user desires to use HOT/Toll lanes. In another example, the request may further include the number of occupants of the vehicle and a request that navigational directions include HOV lanes wherever possible.

In some embodiments, the retrieved road network information is a data structure that represents a graph, as discussed herein, for example, with respect to FIGS. 2 and 3. Such embodiments are scalable for route computation. In some embodiments, road networks are divided into segments that represent unit areas on a map. These segments have ingress and egress points that may be represented by smaller, more granular graphs with edges that have weights. The weights represent the edge properties such as time to traverse, average speed, distance, total toll fees of determined routes, etc. Multiple segments can also be coalesced into a “mega-segment” for ease of data representation and route computation. Such segments or “calculated paths” in each segment are stored in temporary or permanent memory for ready recall in route calculation and search.

At 1110, system 1100 retrieves subsequent road network segment. In some embodiments, based on the straight-line distance between the source and destination, the system 1100 creates termination conditions for the retrieved data structures. For example, if the straight-line or aerial distance between the source and destination is, e.g., 5 units, system 1100 may set a termination condition of a maximum of 10 units of distance in any direction, thus restricting the number of segments to be considered relevant in the search.

At 1112, system 1100 determines whether the retrieved segment contains HOT/HOV roads or lanes. In some embodiments, such information is retrieved from a database local to or remote from system 1100. For example, such information may be retrieved from a third-party service such a navigational or mapping service (e.g., mapping service 145 as discussed with respect to FIG. 1, 1240 as discussed with respect to FIG. 12). If there are no HOT/HOV roads/lanes, system 1100 considers the next relevant segment. In the event that system 1100 determines that the next segment contains an HOV/HOT road or lane, system 1100 proceeds to 1114. In the event that system 1100 determines that it does not, system 1100 proceeds to 1134.

At 1114, system 1100 determines whether the occupancy requirement is met for toll free use. In some embodiments, system 1100 displays a prompt at, e.g., a user equipment device requesting confirmation for the number of occupants of the vehicle. In other embodiments, system 1100 determines the number of occupants, as discussed with respect to 1104. In the event that system 1100 determines that the occupancy requirement is not met, system 1100 proceeds to 1126. In the event that system 1100 determines that the occupancy requirement is met, system 1100 proceeds to 1116.

At 1116, system 1100 determines whether the HOV/HOT lane or road is parallel and adjacent to unrestricted lanes. In some embodiments, such information is retrieved from a database that is local to or remote from system 1100. For example, system 1100 may access a remote database or third-party database that includes roadway information sufficient to determine the presence and location of HOV/HOT/Toll lanes relative to unrestricted lanes. In the event that system 1100 determines that the lane is not parallel to unrestricted lanes, system 1116 proceeds to 1120. In the event that system 1100 determines that the HOV/HOT lanes or roads are parallel and adjacent to unrestricted lanes, system 1100 proceeds to 1118.

At 1118, system 1100 sets the weights of edges of co-located HOT/HOV and unrestricted lanes in the segment based on differentiated vehicle traversal time and HOV/HOT lanes. In some embodiments, based on determining whether the occupancy criteria are met (for example, as determined at 1114), system 1100 uses the HOT/HOV average lane speeds or unrestricted lane average speeds, respectively to determine the time to traverse the road sections in that segment. These traversal times based on the differentiated speeds of HOT/HOV or unrestricted lanes are applied as the weights of the edges representing these roadways. In embodiments where the user opts to incur toll payments, system 1100 applies time traversal in an HOV lane as the edge weight.

At 1120, system 1100 sets weights of edges representing the Express/HOT/HOV roads based on vehicle traversal time. In some embodiments, system 1100 uses the Express/HOT/HOV average lane speeds or unrestricted lane average speeds, respectively to determine the time to traverse the road sections in that segment. These traversal times based on the differentiated speeds of Express/HOT/HOV and unrestricted lanes are applied as the weights of the edges representing these roadways. Techniques for determining and applying edge weights are discuss herein, for example, as discussed with respect to FIGS. 2 and 3.

At 1122, system 1100 determines whether the last segment is relevant to navigation between the start location and the destination. In the event that system 1100 determines that the last segment is not relevant to navigation, system 1100 returns to 1112 and continues from there. In the event that system 1100 determines that the last segment is relevant to navigation, system 1100 proceeds to 1124.

At 1124, system 1100 determines that weight modification of edges is complete and applies the fastest route search algorithm. In an embodiment, the determined data structure (e.g., the collection of road segments between the start location and the destination) is input to the traversal and search algorithm to generate the recommended route(s) once the weights have been adjusted for all the relevant segments. Edges associated with tolls in a segment may be “marked” or represented separately than edges that are associated with HOT lanes where the vehicle occupancy requirement for toll-free use is met. In some embodiments, the search algorithm determines suitable disposition of these edges for calculating the route, e.g., based on user preferences. In some embodiments where the user configured the navigation system to avoid tolls, only the edges that are not associated with tolls are input to the search algorithm. If the search algorithm is unable to determine an acceptable route, in a subsequent iteration, edges with tolls are admitted to the search algorithm input. In this way, system 1100 optimizes traversal times and, in some embodiments, such optimization is based on user preferences.

In some embodiments, system 1100 displays the results to the user. For example, system 1100 displays the determined route(s) to the user at, e.g., a user equipment device. Additionally, system 1100 may additionally display user selectable options that allow the user to select one or more proposed routes. At the conclusion of 1124, system 1100 proceeds to 1150, where system 1100 exits.

Returning to the conclusion of 1114, at 1126, system 1100 determines whether the HOV/HOT lane or road is parallel and adjacent to the unrestricted lanes. In some embodiments, such information is retrieved from a database that is local to or remote from system 1100. For example, system 1100 may access a remote database or third-party database that includes roadway information sufficient to determine the presence and location of HOV/HOT relative to unrestricted lanes. In the event that system 1100 determines that HOV/HOT are not, system 1100 returned to 1120. In the event that system 1100 determines that the HOV/HOT lane or road is parallel and adjacent to unrestricted lanes, system 1100 proceeds to 1128.

At 1128, system 1100 determines whether tolls are permitted. In some embodiments, system 1100 determines such information by accessing a user profile associated with the user and/or the user device. In other embodiments, system 1100 prompts the user (e.g., by user equipment device) to determine whether the user accepts tolls. In another embodiment, system 1100 considers the user's prepaid toll balance information to determine whether the user's prepaid toll balance is sufficient to traverse the HOT/toll roads. If the user's balance is not sufficient, system 1100 determines that toll roads are not permitted. In the event that tools are not permitted (however determined), system 1100 proceeds to 1132. In the event that tolls are permitted, system 1100 proceeds to 1130.

At 1130, system 1100 sets the weights of edges of co-located HOT/HOV and unrestricted lanes in the segment based on differentiated vehicle traversal time in HOT lanes. In some embodiments, based on determining whether the occupancy criteria are met (for example, as determined at 1114), system 1100 uses the HOT/toll average lane speeds or unrestricted lane average speeds, respectively, to determine the time to traverse the road sections in that segment. These traversal times based on the differentiated speeds of HOT/toll lanes or unrestricted lanes are applied as the weights of the edges representing these roadways. In embodiments where the user opts to incur toll payments, system 1100 applies time traversal in an HOT/toll lane as the edge weight. At the conclusion of 1130, system 1100 proceeds to 1122.

At 1132, system 1100 sets weights of edges of edges of co-located HOT/HOV and unrestricted lanes in the segment based on differentiated vehicle traversal times in unrestricted lanes. In some embodiments, system 1100 uses the HOT/HOV average lane speeds or unrestricted lane average speeds, respectively to determine the time to traverse the road sections in that segment. These traversal times based on the differentiated speeds of HOT/HOV and unrestricted lanes are applied as the weights of the edges representing these roadways. In embodiments where the user opts to incur toll payments, system 1100 applies time traversal in an HOV lane as the edge weight. In embodiments where the user elects to avoid toll roads (e.g., as determined with respect to 1128), system 1100 applies time traversal in unrestricted lanes as the edge weight.

Returning to the conclusion of 1112, where system 1100 determines that the segment does not contain an HOT/HOV road or lane, system 1100 proceeds to 1134. At stop 1134, system 1100 determines whether the segment contains a toll road or lane. In some embodiments, such information is retrieved from a database local to or remote from system 1100. For example, such information may be retrieved from a third-party service such a navigational or mapping service (e.g., mapping service 145 as discussed with respect to FIG. 1, 1240 as discussed with respect to FIG. 12). If there are no toll roads/lanes, system 1100 considers the next relevant segment. In the event that the road segment does not contain a toll road, system 1100 returns to 1112. In the event that the segment contains a toll road or lane, system 1100 proceeds to 1136.

At 1136, system 1100 determines whether the toll lane or road is adjacent and parallel to the unrestricted lanes. In some embodiments, such information is retrieved from a database that is local to or remote from system 1100. For example, system 1100 may access a remote database or third-party database that includes roadway information sufficient to determine the presence and location of toll lanes relative to unrestricted lanes. In the event that the toll lane/road is not adjacent and parallel to unrestricted lanes, system 1100 returns to 1120. In the event that toll lane or road is adjacent and parallel to the unrestricted lanes, system 1100 proceeds to 1138.

At 1138, system 1100 determines whether tolls are permitted according to the users driving options. In some embodiments, system 1100 determines such information by accessing a user profile associated with the user and/or the user device. In other embodiments, system 1100 prompts the user (e.g., by user equipment device) to determine whether the user accepts tolls. In some embodiments, system 1100 additionally alerts the user to the estimated tolls incurred to traverse the determined route using toll lanes. In such an embodiment, system 1100 may additionally provide user selectable inputs that allow the user to accept or decline using the toll roads/lanes. In another embodiment, system 1100 considers the user's prepaid toll balance information to determine whether the user's prepaid toll balance is sufficient to traverse the HOT/toll roads. If the user's balance is not sufficient, system 1100 may determine that toll roads are not permitted. In the event that tolls are not permitted, system 1100 proceeds to 1142. In the event that tolls are permitted, system 1100 proceeds to 1140.

At 1140, system 1100 sets the weights of edges of co-located toll and unrestricted lanes in the segment based on differentiated vehicle traversal time in toll lanes. In some embodiments, system 1100 uses the HOT/toll average lane speeds or unrestricted lane average speeds, respectively to determine the time to traverse the road sections in that segment. These traversal times based on the differentiated speeds of HOT/toll and unrestricted lanes are applied as the weights of the edges representing these roadways. In embodiments where the user opts to incur toll payments, system 1100 applies time traversal in an HOT/toll lane as the edge weight. In embodiments where the user elects to avoid toll roads (e.g., as determined with respect to 1138), system 1100 applies time traversal in unrestricted lanes as the edge weight. At the conclusion of 1140, system 1100 returns to 1122.

At 1142, system 1100 sets weights of edges of coal located toll and unrestricted length in the segment based on differentiated vehicle traversal time in unrestricted lanes. In some embodiments, system 1100 uses unrestricted lane average speeds to determine the time to traverse the road sections in that segment. These traversal times based on the differentiated speeds of HOT/toll and unrestricted lanes are applied as the weights of the edges representing these roadways. In embodiments where the user opts to incur toll payments, system 1100 applies time traversal in an HOT/toll lane as the edge weight (e.g., as discussed with respect to 1140). In embodiments where the user elects to avoid toll roads (e.g., as determined with respect to 1138), system 1100 applies time traversal in unrestricted lanes as the edge weight. At the conclusion of 1142, system 1100 returns to 1118.

In another exemplary embodiment of the present disclosure and with reference to FIG. 12, system 1200 includes user equipment 1205, mapping service 1240, server 1250, which communicate with one another using communication network 1230. In some embodiments, server 1250 includes control circuitry 1252, I/O path 1254, and storage 1256. FIG. 12 illustrates generalized embodiments of an illustrative device, e.g., user equipment 105, 905, 1005, 1205. For example, user equipment 1205 may be a smartphone device, a tablet, a computer, dedicated toll transponder, or a remote control, such as illustrative user equipment 1205. In other embodiments, user equipment 1205 is navigational equipment installed or included in a vehicle (e.g., a vehicle navigation system or an infotainment system). In some embodiments, server 1250 may include one or more circuit boards. In some embodiments, the circuit boards may include control circuitry (e.g., control circuitry 1252) and storage (e.g., RAM, ROM, Hard Disk, Removable Disk, etc.) (e.g., storage 1256). In some embodiments, circuit boards may include an input/output path (e.g., I/O Path 1254). In some embodiments, user equipment 1205 may receive content and data via input/output (“I/O”) path 1254. I/O path 1254 may provide content (e.g., mapping data/information available over a local area network (LAN) or wide area network (WAN), and/or other content) and data to control circuitry 1252 and storage 1256. Control circuitry 1252 may be used to send and receive commands, requests, and other suitable data using I/O path 1254. I/O path 1254 may connect control circuitry 1252 to one or more communications paths (described herein). I/O functions may be provided by one or more of these communications paths but are shown as a single path in FIG. 12 to avoid overcomplicating the drawing.

Control circuitry 1252 should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate units, for example, multiple of the same type of processing units (e.g., two Intel Core i7 processors) or multiple different processors (e.g., an Intel Core i5 processor and an Intel Core i7 processor). In some embodiments, control circuitry 1252 executes instructions for an application stored in memory (e.g., storage 1256). Specifically, control circuitry 1252 may be instructed by the application to perform the functions discussed herein. For example, the application may provide instructions to control circuitry 1252 to determine route information and generate the navigational information. In some implementations, any action performed by control circuitry 1252 may be based on instructions received from the application.

In client server-based embodiments, control circuitry 1252 may include communications circuitry suitable for communicating with a user equipment (e.g., user equipment 1205) or other networks or servers. The instructions for carrying out the functionality discussed herein may be stored on the server (e.g., server 1250). Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry (e.g., I/O Path 1254). Such communications may involve the Internet or any other suitable communications networks or paths (e.g., I/O Path 1254). In addition, communications circuitry may include circuitry that enables peer-to-peer communication of user equipment devices, or communication of user equipment devices in locations remote from each other (described in more detail herein).

Memory may be an electronic storage device provided as storage 1256 that is part of control circuitry 1252. As referred to herein, the phrase “electronic storage device” or “storage device” should be understood to mean any device for storing electronic data, computer software, or firmware, such as random-access memory, read-only memory, hard drives, non-transitory computer readable medium, or any other suitable fixed or removable storage devices, and/or any combination of the same. Storage 1256 may be used to store various types of content, navigation data, and instructions for executing content access applications. Nonvolatile memory may also be used (e.g., to launch a boot-up routine and other instructions).

Storage 1256 may additionally be used to implement certain features of the present disclosure. For example, road segments 120 (as discussed with respect to FIG. 1) and 220 (as discussed with respect to FIG. 2) may be stored at storage 1256. In some embodiments, storage 1256 is included at mapping service 145. In another example, storage 1256 may store roadway information including the presence and location of Express/HOV/HOT/toll lanes/roads, as discussed with respect to FIGS. 5 and 7. In another example, storage 1256 may store historical information, as discussed with respect to FIGS. 6 and 7. In another example, storage 1256 may store information related to GPS coordinates and average velocities of vehicles travelling along a roadway, as discussed with respect to FIG. 7. In another example, storage 1256 may store user preferences, as discussed with respect to FIGS. 2, 3, 6, 11.

Control circuitry 1252 may include video-generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 1252 may also include scaler circuitry for upconverting and downconverting content into the preferred output format of the user equipment 1205. Circuitry 1252 may also include digital-to-analog converter circuitry and analog-to-digital converter circuitry for converting between digital and analog signals. The tuning and encoding circuitry may also be used to receive navigation, guidance, and lane restriction data. The circuitry described herein, including for example, the tuning, video-generating, encoding, decoding, encrypting, decrypting, scaler, navigating, and analog/digital circuitry, may be implemented using software running on one or more general purpose or specialized processors. In embodiments where storage 1256 is provided as a separate device from user equipment 1205, the mapping and encoding circuitry may be associated with storage 1256.

A user may send instructions to control circuitry 1252 using a user input interface (e.g., user interface 605A-605G) that is part of user equipment (e.g., user equipment 1205). User input interface (e.g., user interface 605A-605G) may be any suitable user interface, such as a remote control, mouse, trackball, keypad, keyboard, touchscreen, touchpad, stylus input, joystick, voice recognition interface, or other user input interfaces. The user interface (e.g., user interface 605A-605G) may be provided as a stand-alone device or integrated with other elements of each one of user equipment 1205 and system 1200. For example, user interface (e.g., user interface 605A-605G) may be a touchscreen or touch-sensitive display. In such circumstances, user equipment 1205 may be integrated with or combined with user interface 605A-605G.

Mapping service 1240 may be implemented using any suitable architecture. For example, mapping service 1240 may be a stand-alone application wholly implemented on user equipment 1205. In such an approach, instructions for the application are stored locally, and data for use by the application is downloaded on a periodic basis (e.g., from an out-of-band feed, from an Internet resource, or using another suitable approach). Control circuitry at user equipment (e.g., 105, 905, 1005, 1205) retrieves instructions of the application from storage (e.g., storage 1256) and process the instructions to generate any of the displays discussed herein. Based on the processed instructions, control circuitry may determine what action to perform when input is received from input interface (e.g., user interface 605A-605G).

In an embodiment, user equipment 1205 requests navigation from mapping service 1240 using communication network 1230. In such an embodiment, user equipment 1205 can request turn-by-turn navigation, route information, and any other information relevant to travelling using Express/HOV/HOT/toll lanes. In an exemplary embodiment, user equipment 1205 requests navigation from mapping service 1240 using communication network 1230. In such an embodiment, user equipment 1205 requests mapping information relevant to the road segments from a starting location to a final destination. In some embodiments, the starting location is the current location of user equipment 1205. User equipment 1205 displays a user interface that displays various information, for example, traffic information, weather information, identified traffic events, HOV/HOT lane restrictions, toll information, or any other information that may impact user equipment's 1205 journey from the starting location to the final destination. Additionally, the user interface (e.g., user interface 605A-605G) displayed on user equipment 1205 also provides user selectable inputs that switch between navigation routes and/or to input user preferences (e.g., whether to avoid or accept tolls). In some embodiments, user equipment 1205 communicates with mapping service 1240 using communication network 1230 to send and receive navigational information displayed on user equipment 1205.

In another exemplary embodiment, user equipment 1205 stores information. For example, user equipment 1205 stores navigational routes, starting locations, final destinations, points of interest, user preferences, user selections, or other information collected during navigation. Alternatively or in addition, some or all of the computational resources used by user equipment 1205 are implemented at server 1250. For example, information stored at user 1205 can be stored at server 1250, for example, at storage 1256. Additionally, some are all of the methods or processes implemented by user equipment 1205 are implemented at server 1250, for example, at control circuitry 1252. In such an embodiment, information can be communicated between server 1250 and user equipment 1205 over communication network 1230 and using, for example, IO path 1254. In some embodiments, mapping service 1240 is implemented at server 1250.

It is contemplated that some suitable steps or suitable descriptions of FIGS. 1, 7, 11, and 12 may be used with other suitable embodiments of this disclosure. In addition, some suitable steps and descriptions described in relation to FIGS. 1, 7, 11, and 12 may be implemented in alternative orders or in parallel to further the purposes of this disclosure. For example, some suitable steps may be performed in any order or in parallel or substantially simultaneously to reduce lag or increase the speed of the system or method. Some suitable steps may also be skipped or omitted from the process. Furthermore, it should be noted that some suitable devices or equipment discussed in relation to FIGS. 2-6 and 8-10 could be used to perform one or more of the steps in FIGS. 1, 7, 11, and 12.

The processes discussed herein are intended to be illustrative and not limiting. For instance, the steps of the processes discussed herein may be omitted, modified, combined, and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

What is claimed is:

1. A method comprising:
retrieving, from a database, information relating to a plurality of road segments comprising a route between a start location of a vehicle and a destination of the vehicle;
determining a first travel duration for the vehicle to travel from the start location to the destination along the route;
determining whether any road segments of the plurality of road segments include restricted lanes having an occupancy-based restriction; and
in response to determining that at least one road segment of the plurality of road segments includes a restricted lane having an occupancy-based restriction:
determining whether a number of occupants of the vehicle meets or exceeds the occupancy-based restriction;
in response to determining that the number of occupants of the vehicle does not meet the occupancy-based restriction, displaying, at a user equipment device, navigational directions from the start location to the destination that do not include the restricted lane; and
in response to determining that the number of occupants of the vehicle meets or exceeds the occupancy-based restriction:
determining whether a second travel duration for the vehicle to travel from the start location to the destination using the restricted lane is less than the first travel duration;
in response to determining that the second travel duration is less than the first travel duration, displaying, at the user equipment device, navigational directions from the start location to the destination that include the restricted lane; and
in response to determining that the second travel duration is greater than the first travel duration, displaying, at the user equipment device, navigational directions from the start location to the destination that do not include the restricted lane.

2. The method of claim 1, wherein the number of occupants of the vehicle is determined based on information received from a sensor of the vehicle.

3. The method of claim 1, wherein the number of occupants of the vehicle is determined based on user input received from a user input device.

4. The method of claim 1, wherein the user equipment device is a cellular telephone.

5. The method of claim 1, wherein the user equipment device is an infotainment system of the vehicle.

6. The method of claim 1, wherein the user equipment device is a switchable transponder.

7. The method of claim 1 further comprising:
determining whether any road segments of the plurality of road segments include toll restricted lanes having a toll-based restriction;
in response to determining that at least one road segment of the plurality of road segments includes a toll restricted lane having the toll-based restriction:
determining whether a third travel duration for the vehicle to travel from the start location to the destination using the toll restricted lane is less than the first travel duration;
in response to determining that the third travel duration is less than the first travel duration, displaying, at the user equipment device, navigational directions from the start location to the destination that include the toll restricted lane; and
in response to determining that the third travel duration is greater than the first travel duration, displaying, at the user equipment device, navigational directions from the start location to the destination that do not include the toll restricted lane.

8. The method of claim 7, wherein displaying navigational directions from the start location to the destination that include the toll restricted lane is further based on a user profile associated with the user equipment device.

9. A method comprising:
receiving, from a plurality of user equipment devices, a plurality of vehicle speeds, each vehicle speed of the plurality of vehicle speeds corresponding to a vehicle associated with a respective user equipment device, wherein each vehicle of the plurality of vehicles is travelling on a roadway comprising a first lane and a second lane;
grouping the plurality of vehicle speeds into a first group of vehicles and a second group of vehicles;
determining a first average speed corresponding to the average speed of the first group of vehicles;
determining a second average speed corresponding to the average speed of the second group of vehicles;
determining, based on the first average speed and the second average speed, that the first group of vehicles is associated the first lane and the second group of vehicles is associated with the second lane, wherein the first average speed is lower than the second average speed; and
displaying, at a first user equipment device, navigational directions that include the second lane.

10. The method of claim 9 further comprising:
receiving, from the plurality of user equipment devices, a plurality of vehicle locations, each vehicle location of the plurality of vehicle locations corresponding to a vehicle of the plurality of vehicle locations associated with a respective user equipment device of the plurality of user equipment devices;
wherein determining that the first group of vehicles is associated the first lane and the second group of vehicles is associated with the second lane is further based on the received vehicle locations.

11. The method of claim 9 further comprising:
determining that an emergency vehicle is travelling in the second lane; and
displaying, at the first user equipment device, navigational directions that include the first lane.

12. The method of claim 9 further comprising:
determining that an emergency vehicle is travelling in the first lane; and
displaying, at the first user equipment device, navigational directions that include the second lane.

13. A system comprising:
a memory configured to store mapping information;
input/output circuitry configured to:
retrieve, from a database, information relating to a plurality of road segments comprising a route between a start location of a vehicle and a destination of the vehicle;
control circuitry configured to:
determine a first travel duration for the vehicle to travel from the start location to the destination along the route;
determine whether any road segments of the plurality of road segments include restricted lanes having an occupancy-based restriction; and
in response to determining that at least one road segment of the plurality of road segments includes a restricted lane having an occupancy-based restriction:
determine whether a number of occupants of the vehicle meets or exceeds the occupancy-based restriction;
in response to determining that the number of occupants of the vehicle does not meet the occupancy-based restriction, display, at a user equipment device, navigational directions from the start location to the destination that do not include the restricted lane; and
in response to determining that the number of occupants of the vehicle meets or exceeds the occupancy-based restriction:
determine whether a second travel duration for the vehicle to travel from the start location to the destination using the restricted lane is less than the first travel duration;
in response to determining that the second travel duration is less than the first travel duration, display, at the user equipment device, navigational directions from the start location to the destination that include the restricted lane; and
in response to determining that the second travel duration is greater than the first travel duration, display, at the user equipment device, navigational directions from the start location to the destination that do not include the restricted lane.

14. The system of claim 13, wherein the number of occupants of the vehicle is determined based on information received from a sensor of the vehicle.

15. The system of claim 13, wherein the number of occupants of the vehicle is determined based on user input received from a user input device.

16. The system of claim 13, wherein the control circuitry is further configured to:
determine whether any road segments of the plurality of road segments include toll restricted lanes having a toll-based restriction;
in response to determining that at least one road segment of the plurality of road segments includes a toll restricted lane having the toll-based restriction:
determine whether a third travel duration for the vehicle to travel from the start location to the destination using the toll restricted lane is less than the first travel duration;
in response to determining that the third travel duration is less than the first travel duration, display, at the user equipment device, navigational directions from the start location to the destination that include the toll restricted lane; and
in response to determining that the third travel duration is greater than the first travel duration, display, at the user equipment device, navigational directions from the start location to the destination that do not include the toll restricted lane.

17. The system of claim 16, wherein displaying navigational directions from the start location to the destination that include the toll restricted lane is further based on a user profile associated with the user equipment device.

18. The system of claim 13, wherein the user equipment device is a cellular telephone.

19. The system of claim 13, wherein the user equipment device is an infotainment system of the vehicle.

20. The system of claim 13, wherein the user equipment device is a switchable transponder.
